(19) United States
(12) Patent Application Publication
(10) Pub. No.: US 2026/0368281 A1
(43) Pub. Date: Nov. 19, 2026

(54) METHOD AND SYSTEM FOR BINARY DATA MODEL SEARCH AND MODIFICATION

(71) Applicant: Scaled Sources LLC, Chicago, IL (US)

(72) Inventor: William TEGEL, Chicago, IL (US)

(73) Assignee: Scaled Sources LLC, Chicago, IL (US)

(21) Appl. No.: 19/683,274

(22) Filed: May 20, 2026

Related U.S. Application Data
(63) Continuation-in-part of application No. 18/815,116, filed on Aug. 26, 2024.
Application No. 18/815,116 is a continuation-in-part of application No. 18/046,500, filed on Oct. 13, 2022, now Pat. No. 12,101,388.

(51) Int. Cl. G06F 18/241; G06F 16/25; G06F 16/28

(52) U.S. Cl. CPC G06F 18/241; G06F 16/258; G06F 16/288

(57) ABSTRACT

A system and method for searching and manipulating binary data models is provided. A generic binary data model describing the structure and semantics of binary data and a set of search criteria are received by a binary data model retriever. The retriever identifies and selects model portions within the generic binary data model having model elements that satisfy the search criteria. The selected model portions are provided to a binary data model manipulator, which applies a set of manipulation operations to transform the selected model portions, including adding, removing, editing, rearranging, or combining portions of the model. The manipulator recombines the transformed model portions into a modified binary data model. The modified binary data model is usable to generate programs or intermediate representations that act on binary data described by the generic binary data model, including programs for processing headers, performing protocol-specific transformations, or efficiently compressing encoded data.

### RELATED APPLICATIONS

This application is a continuation-in-part of U.S. patent application Ser. No. 18/046,500 “Universal Binary Specification Model” filed on Oct. 13, 2022, which is hereby incorporated by reference in its entirety.

This application is also a continuation-in-part of U.S. patent application Ser. No. 18/815,116 “Binary Data Model Compiler” filed on Aug. 26, 2024, which is hereby incorporated by reference in its entirety.

### TECHNICAL FIELD

Embodiments of the present disclosure relate to modeling binary communication protocols, binary data storage formats, and binary data processing architectures. More particular aspects relate to searching and modifying a generic binary data model.

### BACKGROUND

Electronic communication protocols define the rules and conventions that enable efficient data exchange between computing devices, including servers, personal computers, mobile devices, embedded systems, and/or household appliances. Such protocols specify how information is formatted, transmitted, interpreted, and validated across networks or other communication channels. Numerous electronic communication protocols exist, each optimized for particular performance, reliability, and interoperability requirements.

Many such electronic communication protocols employ binary encodings in which message structure and meaning are defined by an external specification rather than being included in the transmitted data. A binary data model can represent these specifications as machine-processable elements (e.g., messages, fields, types, rules, actions, and dependencies) that enable software tools to parse, validate, transform, and generate code for protocol implementations. Current tools, however, lack systematic mechanisms for searching and modifying these binary models to facilitate customization of binary protocols for specific use cases.

Accordingly, there is a need for improved systems and methods that enable precise navigation and manipulation of generic binary data models to produce modified models suitable for a wide range of binary data processing and generation tasks.

### SUMMARY

Systems and methods for searching and manipulating generic binary data models according to the present disclosure improve on prior art binary protocol tooling in various significant ways. For example, the disclosed systems may enable declarative search, navigation, selection, and transformation of binary data model components without requiring manual editing of protocol specifications or direct modification of generated code. The binary data model retriever may search binary data models matching on binary fields, messages, types, rules, properties, and/or metadata, thereby facilitating precise targeting of binary data model elements for customization and analysis.

Additionally, the binary data model manipulator of the present disclosure may apply reusable transformation instructions to selected model portions of a generic binary data model and recombine the transformed elements into a modified binary data model suitable for downstream code generation and analysis. This approach may support flexible specialization of protocol models for tasks such as header processing, line-integrity monitoring, compression, analytics, and storage, while remaining platform-independent, language-independent, and extensible across multiple protocols and programming language source code generation targets.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a block diagram of an embodiment of a binary data model transformation engine for transforming a generic binary data model into a modified binary data model.

FIG. 2 illustrates a block diagram of an embodiment of a binary data model navigator for receiving binary data model navigation criteria and identifying selected model portions of a generic binary data model.

FIG. 3 illustrates a flowchart of an embodiment of a process for parsing binary data model navigation criteria and identifying selected model portions within a generic binary data model using a binary data model navigator.

FIG. 4 illustrates a block diagram of an embodiment of a binary data model querier for identifying selected model portions from a generic binary data model based on selection criteria.

FIG. 5 illustrates a flowchart of an embodiment of a process for parsing selection criteria and identifying selected model portions within a generic binary data model.

FIG. 6 illustrates a block diagram of a binary data model querier including a binary data model qualifier module and a binary data model calculator module for evaluating selection criteria and identifying selected model portions of a generic binary data model.

FIG. 7 illustrates a block diagram of an embodiment of a binary data model manipulator for applying manipulation instructions to a generic binary data model to produce a modified binary data model.

FIG. 8 illustrates a block diagram of an embodiment of a binary data model manipulator for applying a plurality of edits to a generic binary data model and a binary data model harmonizer for resolving dependencies to produce a manipulated binary data model.

FIG. 9 illustrates a flowchart of an embodiment of a process for applying manipulation instructions to a generic binary data model, including determining search criteria, identifying selected model portions, applying manipulation operations, and resolving dependencies.

FIG. 10 illustrates a block diagram of an embodiment of a binary data model elaborator for applying elaboration options to a generic binary data model to produce a specialized binary data model.

FIG. 11 illustrates a flowchart of an embodiment of a process for applying elaboration options to a generic binary data model to produce a specialized binary data model.

FIG. 12 illustrates a block diagram of an embodiment of a binary data model transformation engine including a binary data model retriever, a binary data model navigator, a binary data model querier, a binary data model manipulator, a binary data model harmonizer, and a binary data model elaborator.

FIG. 13 illustrates a flowchart of an embodiment of a process for transforming a generic binary data model into a modified binary data model by parsing transformation instructions into search criteria, manipulation instructions, and elaboration options and applying the parsed instructions.

FIG. 14 illustrates a schematic diagram of an embodiment for linearizing a hierarchical binary data model into a linearized representation.

FIG. 15 illustrates a schematic diagram of an embodiment for identifying and subordinating binary data model dependencies.

FIG. 16 illustrates a block diagram of an embodiment of a binary data model compactor for refining and deduplicating type representations within a binary data model.

FIG. 17 illustrates a schematic diagram of an example embodiment for generating a modified binary data model by selecting and removing messages of a binary communication protocol.

FIG. 18 illustrates a schematic diagram of an example embodiment for transforming a plurality of protocol layers into a unified intermediate representation using binary data model navigation and manipulation operations.

FIG. 19 illustrates a schematic diagram of an embodiment of a binary data model compiler system configured to generate specialized binary data model representations and target outputs based on compiler options.

FIG. 20 illustrates a schematic diagram of an embodiment of a computing system for implementing a binary data model transformation engine.

### DETAILED DESCRIPTION

Generally, electronic communication protocols fall into three broad categories. A first category consists of fully self describing protocols, in which the structure and semantic meaning of transmitted-data are explicitly encoded within the transmitted data itself. Fully self describing protocols encode not only the semantic purpose of each field but also each-field's relative location within the transmitted data. A receiver of a self describing protocol can determine both structure and meaning without consulting-an external schema, aside from basic knowledge of the underlying encoding rules. This design favors debuggability, generic tooling, and ad hoc manipulation. Examples include JavaScript Object Notation (JSON), eXtensible Markup Language (XML), and early Internet protocols such as HTTP, MIME, and HTML, which were designed with interpretability and extensibility as primary goals. As a result, a broad ecosystem of generic tools exists for processing these formats, including JSON parsers, XML processors, and protocol aware proxies and analyzers.

A second category consists of partially described protocols, which embed limited metadata or structural cues within the message while relying on external schema information for full interpretation. This hybrid approach attempts to balance efficiency with adaptability. Embedded information such as field identifiers, type tags, lengths, or version markers allows a receiver to parse and evolve messages without full prior knowledge of their structure, while higher level semantics remain defined separately. Financial Information eXchange (FIX) is an-example: FIX messages use numeric tag identifiers and delimiter—or length based framing, enabling generic parsing while requiring the FIX specification-- to interpret tag semantics. Other examples of partially described protocols include Protocol Buffers, gRPC, Apache Thrift, ASN.1 encodings such as BER and DER, and various tag length value (TLV) formats. Newer internet protocols such as HTTP/2 and HTTP/3-may-also employ partially self describing binary framing layers, where frames carry type identifiers and lengths-but the meaning of each frame type is defined externally.

A third category consists of non-self describing or externally described protocols, which include little or no metadata in the-transmitted data itself. Field boundaries, types, encodings, and semantic meaning are defined entirely by an external specification, and correct interpretation requires prior knowledge of that specification. This approach enables highly compact representations and predictable performance characteristics, and is commonly used in systems where throughput, latency, or deterministic parsing is critical. Examples include many network layer and transport layer protocols, fixed layout binary file formats, embedded device interfaces, and high performance-financial market data feeds.

Across-all three categories, the protocol's conceptual data model remains distinct from any particular encoding, language binding, or software implementation. However, the degree to which that model is made explicit in the data stream has significant implications for how easily communication protocols can be analyzed, transformed, validated, and/or evolved. Fully self describing protocols externalize less semantic knowledge into tooling, while externally-described protocols concentrate that knowledge almost entirely in specifications and code. Partially described protocols expose enough structure to support some evolution and generic processing but cannot fully optimize for compactness or ease of processing.

A key difficulty with externally described protocols is the effort required to understand, read, and modify the protocol. Because structure and semantics are defined entirely outside of the transmitted data, even small changes to field layout, encoding, or meaning typically require coordinated updates across specifications, implementations, and downstream clients. Backward and forward compatibility must be managed explicitly, often through versioned message formats or parallel protocol variants, and errors in interpretation can be silent and difficult to detect. Historically, tooling for externally described protocols is usually bespoke and tightly coupled to a specific protocol version and output programming language. Parsers, analyzers, and transformers are commonly hand written or generated from protocol specific definitions, and generic inspection-tools provide limited value without-deep protocol awareness. While this approach enables maximal efficiency on the wire, it increases development cost, slows iteration, and raises the risk of divergence between a protocol's conceptual data model and its concrete implementations.

Existing approaches for working with binary data models typically focus on generating code directly from a specification or schema into a fixed target representation, such as a parser, decoder, or class model. These approaches treat the protocol specification as a static artifact and offer limited ability to query, subset, recombine, or transform the protocol model itself prior to code generation. Developers who wish to customize a protocol for a specific use case—such as isolating a subset of messages, extracting only header fields, normalizing fields—across protocol versions, or preparing a reduced model for compression or analytics—often resort to ad hoc manual edits or custom tooling.

Modern software systems provide expressive mechanisms for declarative querying and transformation of self-describing data models, including XPath, SQL, regular expressions, and domain specific languages. However, these techniques are generally applied to textual, hierarchical, or relational data representations and are not designed to operate directly on the conceptual model of a binary communication protocol or binary file format.

There is therefore a technical gap between, on one hand, the existence of rich and easily addressable binary data models that describe the structure and semantics of binary data, and, on the other hand, the lack of a systematic mechanism to search, navigate, select, and transform such models prior to program generation. In particular, there is a need for a system that can address every component of a binary data model—including fields, messages, types, rules, enumerations, constants, and implicit indexes—using deterministic addresses; apply selection criteria based on both physical properties and conceptual metadata; and execute transformations that modify, combine, or specialize the model in a controlled and verifiable manner.

Without such a mechanism, the customization of binary data processing systems remains labor intensive, error prone, and tightly coupled to domain specific programming languages- and use cases.-This limitation impedes reuse of protocol definitions across multiple targets, inhibits systematic optimization for specialized workloads, and constrains the ability to generate intermediate representations tailored to downstream processing tasks such as compression, storage, analytics, or cross protocol normalization.

Accordingly, there-is a need for improved systems and methods that treat a binary data model itself as a first class, addressable, queryable, and transformable artifact, enabling precise-navigation and manipulation of generic binary data models to produce modified models suitable for a wide range of binary data processing and generation tasks.

For example, widely used market data and messaging protocols such as National Association of Security Dealers Automated Quotations (NASDAQ) TotalView-ITCH (ITCH), a high-performance binary protocol promulgated by NASDAQ for broadcasting financial market data, and other exchange feed formats, define dense binary layouts containing repeating groups, variable-length fields, enumerations, and cross-message dependencies. A developer may wish to generate a specialized program that extracts only instrument definitions, timestamps, and order book update messages from such a feed, while omitting administrative or rarely used message types. In another case, a system may require a reduced version of a protocol model that retains only header fields and sequencing information in order to build a lightweight line-integrity monitor or packet validation tool. Absent a structured mechanism for navigating and transforming the underlying protocol model, these use cases typically require duplicating or manually editing large portions of the protocol specification and maintaining parallel variants over time.

The techniques of the present disclosure overcome the limitations of the prior art by providing a flexible, composable, platform-independent, and language-independent system for navigating and manipulating binary data models. In particular, the present disclosure discloses systems and methods for treating a binary protocol model, binary storage format model, or any complete binary data model as a first-class structured artifact that can be programmatically searched, queried, selected, transformed, and recombined prior to generating target programming language source code.

The present disclosure describes the invention primarily in the context of binary communication protocols. However, the principles described herein are fully applicable to all types of binary information including, not only binary communication protocols, but also binary data storage formats and binary data processing architectures. For example, the techniques described herein may be applied to packet header formats, file container formats, FPGA packet processing architectures, hardware register layouts, or any other system in which binary layout and semantics are defined by a structured binary specification. Thus, although the present disclosure uses examples mainly drawn from financial market data protocols such as NASDAQ TotalView-ITCH, order entry protocols, and schema-based encodings such as Simple Binary Encoding (SBE), the principles disclosed herein are applicable to other binary information sources including ASN.1 specifications, C or C++ struct definitions, Verilog definitions, SQL schemas, and other descriptions of binary data.

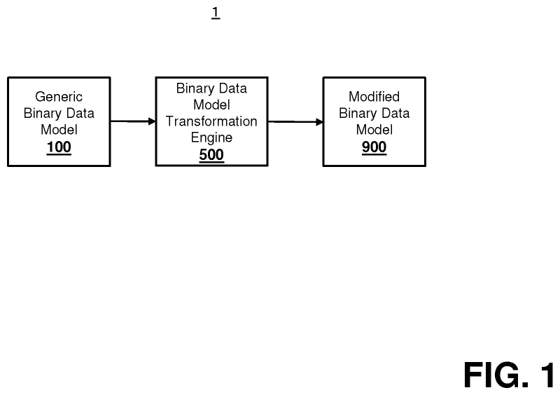

Turning now to the figures, FIG. 1 illustrates a block diagram of a binary data model management system 1 incorporating a generic binary data model 100, a binary data model transformation engine 500, and a modified binary data model 900. An exemplary process for producing a generic binary data model is described in detail in U.S. patent application Ser. No. 18/815,116 filed on Sept. 26, 2024, which is subject to assignment to the applicant of the present application and thereby incorporated by reference in its entirety.

In one or more embodiments, the generic binary data model 100 may include one or more hierarchical structures of binary data model elements representing the structure and interpretation of binary data. Binary data is sequential and dependency constrained. The hierarchical structure may be represented as a tree in which binary data model elements are connected by parent-child relationships. In such a structure, each binary data model element may be connected to multiple descendant elements but to at most one parent element, except for a root element that has no parent. This arrangement produces an acyclic hierarchical structure in which each binary data model element may serve as the root of a subordinate subtree.

The binary data model elements represent the structural and semantic components required to interpret the sequences of bits and bytes of a binary communication protocol, binary data storage format or binary data processing architecture. These binary data elements may include definitions of binary fields, structural groups such as messages or headers, type definitions, and characteristics, and rules governing sequential interpretation of the binary data. In some embodiments, the generic binary data model may further include actions or behavioral annotations associated with particular elements. In some embodiments, the generic binary data model may include multiple trees of binary data elements.

In one or more embodiments, the binary data model transformation engine 500 according to the present disclosure, receives as input a generic binary data model 100 describing the structure and semantics of binary data. The generic binary data model 100 may represent a binary communication protocol, binary data storage format, and/or binary data processing architecture as a normalized collection of model elements including messages, fields, groups, types, enumerations, constants, rules, constraints, metadata attributes, implicit indexes, offsets, lengths, and dependency relationships between elements. The generic binary data model 100 may be derived from one or more protocol descriptions or format definitions including XML schemas, Portable Document Format (PDF) protocol documents, source code definitions, declarative format descriptions, or other structured or semi-structured specification sources as described in detail in U.S. patent application Ser. No. 18/046,500 filed on Oct. 13, 2022, which is incorporated by reference in its entirety.

In one or more embodiments, the generic binary data model 100 may include a plurality of binary data model elements, wherein each binary data model element has a unique location within the binary data model and a set of normalized properties. The properties of the binary data model elements may include physical layout properties such as bit width, byte length, offset, alignment, endianness, and repetition count, as well as semantic properties including field name, message name, type classification, enumeration membership, value constraints, and conceptual relationships to other elements. In addition to intrinsic properties, which can be inferred directly from the element traits derived from the generic binary data model, the binary field property set may further include derived properties such as computed offsets, calculated sizes, dependency references, or cross-message relationships.

In one or more embodiments, aspects of the present disclosure relate to providing stable and deterministic addressing of each binary data model element within the generic binary data model 100. Deterministic addresses may be derived from structural relationships within the hierarchical model and may uniquely identify elements independent of identifiers used in an originating specification as described in detail in U.S. patent application Ser. No. 18/815,116 “Binary Data Model Compiler” filed on Aug. 26, 2024.

As illustrated in FIG. 1, the binary data model transformation engine 500 receives the generic binary data model 100 and applies transformation operations to produce a modified binary data model 900. The binary data model transformation engine 500 may comprise components configured to search the model, select subsets of model elements, apply manipulation operations to those elements, and recombine the transformed elements into a modified binary data model 900. The resulting modified binary data model 900 may be a new protocol corresponding to a different ordering and interpretation of binary data, or it may retain properties of the original generic binary data model 100, including consistent encoding of structural relationships and addressing conventions, while reflecting additional structures useful for further use of the binary data model 100.

The modified binary data model 900 can include a subset, modification, or reorganization of the model elements present in the generic binary data model 100. The modified binary data model 900 may retain selected messages, fields, types, rules, or dependencies while removing or modifying other elements. The modified binary data model 900 may also include derived elements, normalized attributes, or updated dependency relationships introduced during transformation. In some embodiments, the modified binary data model 900 may include multiple root nodes, multiple generic binary data models 100, and data useful for the transformation process that is not in the form of a generic binary data model 100.

The modified binary data model 900 may subsequently be provided to downstream programming language target generators, or processing systems configured to produce executable programs, refined intermediate representations, or analyzers that operate on binary data described by the model.

Some exemplary benefits of the techniques of the present disclosure as compared to the prior art include reducing or eliminating manual editing of binary protocol specifications, reducing the need for bespoke protocol-specific parsers and transformations, enabling more efficient binary protocol processing through generation of specialized programs, and enabling more efficient and flexible manipulation of binary data model components through reusable declarative selection and transformation rules. As such, the techniques of the present disclosure can be understood to provide an improvement in the functioning of the computer itself, including reduced developer effort, reduced maintenance burden, reduced error rate, faster protocol evolution, and more efficient processing of binary information.

In some embodiments, the binary data model transformation engine may include a binary data model retriever 510 configured to facilitate search, identification, selection, and retrieval of particular portions (e.g., also referred to as a set of selected binary data model portions herein) of the generic binary data model 100. As used herein, the set of selected model portions may refer to portions of the generic binary data model 100 that include binary model elements that match or otherwise satisfy a set of search criteria 610. The binary data model retriever 510 may include a binary data model navigator 512 and a binary data model querier 516. While the binary data model navigator 512 and the binary data model querier 516 may both be generally understood to parse a set of transformation instructions 600 defining how a generic binary data model 100 is to be modified in order to extract a set of search criteria 610 and subsequently use this set of search criteria 610 to identify the set of selected model portions of the generic binary data model 100, the binary data model navigator 512 and the binary data model querier 516 may employ different methods of searching the generic binary data model 100. For example, in one or more embodiments, the binary data model navigator 512 may search for binary data model elements using search criteria 610 including a set of navigation criteria such as address search parameters, and the binary data model querier 516 may search for binary data model elements based on search criteria 610 including selection criteria defining descriptive characteristics such as names, properties, traits, or other properties of the binary model and binary data model elements. Accordingly, as used herein, the search criteria 610 may be understood to include the navigation criteria used by the binary data model navigator 512 and the selection criteria used by the binary data model querier 516. The binary data model retriever 510 may use one of either the binary data model navigator 512 or the binary data model querier 516 separately, or use both of the binary data model navigator 512 or the binary data model querier 516 to facilitate search of the generic binary data model 100.

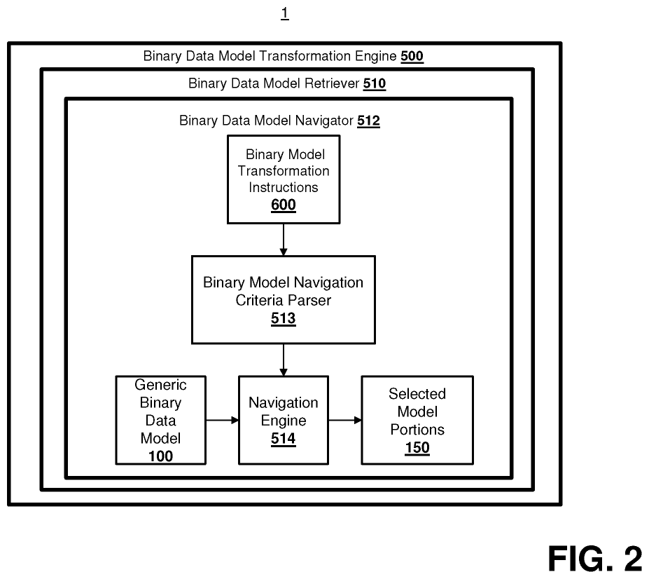

FIG. 2 illustrates a block diagram of a binary data model management system 1 that uses a binary model navigator 512 to interpret binary model address information. More specifically, FIG. 2 shows that the binary model navigator 512 uses a binary model navigation criteria parser 513 to parse a set of binary model transformation instructions 600 to derive a set of navigation criteria as the set of search criteria 610. The set of navigation criteria may be understood to be a subset of the set of search criteria 610 including, for instance, address search parameters. These navigation criteria may be sent to a navigation engine 514. The navigation engine 514 then uses the parsed address search parameters of the navigation criteria to iteratively explore the generic binary data model 100 until it identifies a matching binary data model component that corresponds to the navigation criteria sought in the address information of the original generic binary data model 100.

In some embodiments, the binary model transformation instructions 600 may include binary data model search parameters. These binary data model search parameters may include one or more of: binary data model name matching, type matching, characteristic matching, structural position matching, dependency matching, or conceptual relationship matching. For example, the binary model search parameters may select all message elements containing a particular substring in their name, all fields that represent timestamps, all elements belonging to a particular protocol layer, all fields whose width exceeds a threshold, all fields located within a header region, or all enumerations used by a particular message family.

In one or more embodiments, the binary model navigation criteria parser 513 may include an address parser and a binary data model element lookup engine configured to resolve textual, structured, or programmatic address expressions in the binary model transformation instructions 600 into deterministic binary data model addresses. Binary data model address expressions may be absolute, relative, namespace-qualified, partially specified, or pattern-based. The binary model navigation criteria parser 513 can parse the binary model transformation instructions 600 to derive navigation criteria, including address search parameters that identify the location of one or more model elements within the generic binary data model based on their associated address information.

In one or more embodiments, the navigation engine 514 of the binary data model navigator 512 may use the address search parameters of the navigation criteria derived by the navigation criteria address parser 513 to search the generic binary data model 100 and produce a set of selected model portions 150 including model elements that match or satisfy the navigation criteria of the search criteria 610. The selected model portions 150 may include addresses for the selected elements and may include ordered lists of element attributes sufficient for downstream manipulation.

In one or more embodiments, binary data model addresses may be expressed in relative form. An example of a binary data model address may be “packet.message.addorder.price”.

In this example, the binary data model address is composed of an ordered list of binary data model element names corresponding to the hierarchical structure of the generic binary data model 100. The first addressed element, “packet”, corresponds to a binary data model element with Name: “Packet”, representing a container element that groups one or more message elements within a protocol packet. The next addressed element, “message”, corresponds to a binary data model element with Name: “Message”, representing a grouping of protocol message structures contained within the packet element. The next addressed element, “addordermessage”, corresponds to a binary data model element of semantic type “Message” with Name: “AddOrderMessage”, representing a specific message type defined by the protocol. The final addressed element, “price”, corresponds to a binary data model element with Name: “Price”, representing a binary field contained within the AddOrder message.

In one embodiment, the ordered list of binary data model element names {Packet, Message, AddOrderMessage, Price} forms the binary data model element address. The binary data model address may be represented in a variety of forms including dot-notation such as “packet. message. addordermessage. price”, directory notation, concatenated identifiers, or other representations that preserve the ordered hierarchy of the binary data model elements. Binary data model element addresses are unique within a binary data model because each binary data model element occupies a unique position within a hierarchical binary data model tree and each binary model tree is unique within a binary data model.

The binary data model element with Name: “Price” may contain one or more associated binary data model components, including but not limited to types, values, rules, binary type traits and characteristics, and actions, as described in U.S. patent application Ser. No. 18/815,116. These components together define the interpretation, constraints, and behavior of the binary data field within the binary data model.

In some embodiments, the navigation engine 514 of the binary data model navigator 512 is configured to resolve binary data model addresses described in the transformation instructions 600 into address search parameters specifying an exact location within the generic binary data model 100. Relative addresses may be interpreted in the context of a current namespace or traversal root and resolved by the lookup engine into a deterministic address within the generic binary data model 100.

In one or more embodiments, addresses may be expressed in a global, fully qualified form, such as:
“nasdaq.equities.totalview.itch.v5.0.packet.message.addorder.price”

In one or more embodiments, address expressions may be resolved using search and matching methods rather than strict hierarchical traversal. For example, an address searcher such as the navigation engine 514 may match the address fragments “addordermessage” and “price” and resolve the combination by applying filters and descendant matching to locate a Price child field of the AddOrderMessage binary data model element within the NASDAQ ITCH model. Such matching may support partial qualification, wildcard segments, trait filters, or logical operators. The navigation engine 514 may return a unique deterministic address corresponding to a model element, may return the nearest matching element within a specified threshold, or may return an error message or null response if no suitable match is identified.

In one example embodiment, a search expression of an address search parameter containing the fragments “addorder” and “price” may match a binary data model element with Name: “Price” that is a child field of a binary data model element with Name: “AddOrderMessage” within a namespace corresponding to NASDAQ TotalView ITCH. The resulting deterministic address may be represented as nasdaq.equities.totalview.itch.packet.message.addordermessage.price, although other representations preserving the same ordered hierarchy may be used.

In another example embodiment, a search expression of an address search parameter may include wildcard segments. For example, an address search expression of an address search parameter such as *price may match the Price field of the AddOrderMessage across multiple protocols or protocol versions. In such an embodiment, the address searcher such as the navigation engine 514 may return multiple deterministic addresses corresponding to each matching model element.

In another example embodiment, a search expression of a binary model address search parameter may include trait-based predicates or logical operators. For example, a search expression of an address search parameter may request fields named “price” within messages containing an order identifier, or fields with a trait corresponding to a price value type within AddOrderMessage structures. The binary data model address searcher may evaluate such trait filters against the normalized components of the binary data model elements to identify matching elements.

In one or more embodiments, every binary data model element and binary data model element property of the generic binary data model 100 is addressable. Addressable elements may include structural elements, semantic elements, and behavioral elements associated with the binary protocol definition. For example, the following elements may each be assigned or derived as deterministic addresses within the generic binary data model 100:
a binary data model element representing a field, such as the Price field within the AddOrderMessage
a binary data model value of an element, such as an enumerated value or a protocol constant defining a message type identifier.
a binary data model action or property representing a synthetic or derived field such as an implicit sequence number
a binary data model element representing an action, such as a behaviour indicating that a packet sequence number needs to increment

For example, an enumerated value representing Buy within a Side enumeration may be addressed using a deterministic address corresponding to the hierarchical structure of the generic binary data model 100, such as packet.message.addorder.side:buy. Similarly, a constant representing a message identifier may be addressed using an address corresponding to the location of the constant within the binary data model as packet.message.addorder:messagetype.

In one or more embodiments, the navigation engine 514 of the binary data model navigator 512 may be configured to address derived fields. For example, a synthetic message sequence number derived from transport headers may be assigned a deterministic address such as:
“packet.header.message.messagesequencenumber.” Even though a synthetic element may not appear explicitly in the sequential binary data or in the original protocol specification, it is fully addressable within the generic binary data model 100 once introduced. In one or more embodiments, each such element is assigned or derivable as a deterministic address independent of specification-level identifiers such as field numbers, offsets, or protocol documentation labels. The deterministic address is derived from the structural and semantic relationships of the elements within the generic binary data model 100 rather than from identifiers defined in the original protocol specification.

In one or more embodiments, the navigation engine 514 of the binary data model navigator 512 may be binary data model element type aware and may optionally skip implicit or structural elements when resolving addresses. For example, an address expression may omit intermediate elements such as “payload” for branch elements. Thus:
“packet.message.addorder.price”
   may resolve equivalently to:
“packet.message.payload.addorder.price” or
“packet.payload.message.addorder.payload.price”
   where “payload” is a binary data model branch node.

In one or more embodiments, namespaces can be used to make addressed elements within the same protocol unique. For example, when there are two prices expressed with distinct binary type traits, such as one being large::price in the context of instrument type “A” and the second expressed as short::price in the context of instrument type “B,” the navigator can establish a distinction between the two by, for example, referring to A. price and B. price, where “A” and “B” are namespaces. The binary data model navigator 512 resolves the fully qualified path into a unique deterministic binary data model element address corresponding to a model element.

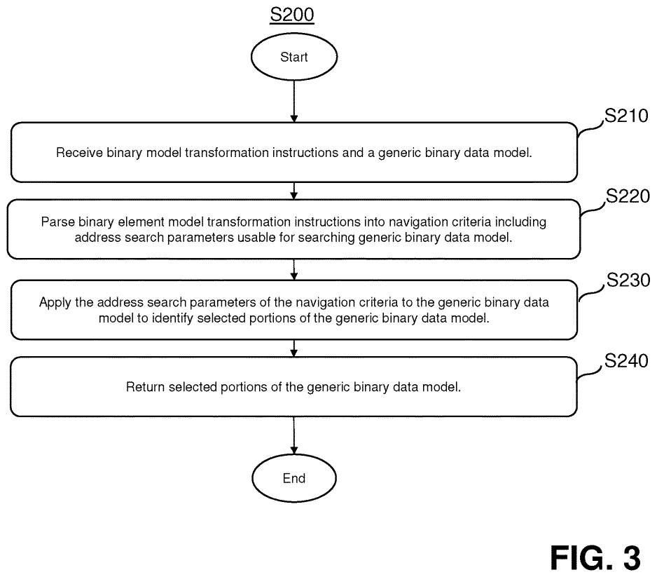

FIG. 3 illustrates an example process S200 performed by the binary data model navigator 512 according to the embodiments of the present disclosure to identify model elements within a generic binary data model 100.

First, at Step S210, the process begins with the binary data model navigator 512 receiving binary model transformation instructions 600 together with a generic binary data model 100. As described herein, the transformation instructions 600 may include instructions defining modifications to be performed to the generic binary data model 100.

Next, at Step S220, in one or more embodiments, the binary model navigation criteria parser 513 of the binary data model navigator 512 parses the received binary model transformation instructions 600 into search criteria 610 usable for searching or matching within the generic binary data model 100. In some embodiments, the parsing may include converting textual, structured, or programmatic address expressions into binary data model search criteria 610 including navigation criteria such as normalized address search parameters that can be used to search the generic binary data model 100.

Next, at Step S230, the navigation engine 514 of the binary data model navigator 512 applies the resulting address search parameters of the navigation criteria to the generic binary data model 100. This process may involve traversing hierarchical relationships, evaluating metadata attributes, or matching address components to structural elements within the model.

During navigation, the navigation engine 514 of the binary data model navigator 512 iteratively examines model elements of the generic binary data model 100 to determine whether each model element satisfies the derived address search parameters of the navigation criteria included in the search criteria 610. In one or more embodiments, the navigation engine 514 of the binary data model navigator 512 may maintain intermediate state information representing partially matched address segments or candidate element sets.

Upon identifying one or more model elements satisfying the navigation criteria included in the search criteria 610 within the generic binary data model 100, the navigation engine 514 of the binary data model navigator 512 may resolve deterministic addresses for the selected model elements within the generic binary data model, and gather the candidate portions of the generic binary data model 100 including the identified model elements to prepare them for output as the selected model portions 150. The identified elements included in the selected model portions 150 may represent model elements located within the generic binary data model 100 according to the supplied address information. The deterministic addresses may be derived from at least one of a structural position, hierarchical path, canonical ordering, or content-derived hashing of the set of model elements.

At Step S240, the navigation engine 514 of the binary data model navigator 512 then returns the selected model portions 150 of the generic binary data model 100 as the output of the process S200.

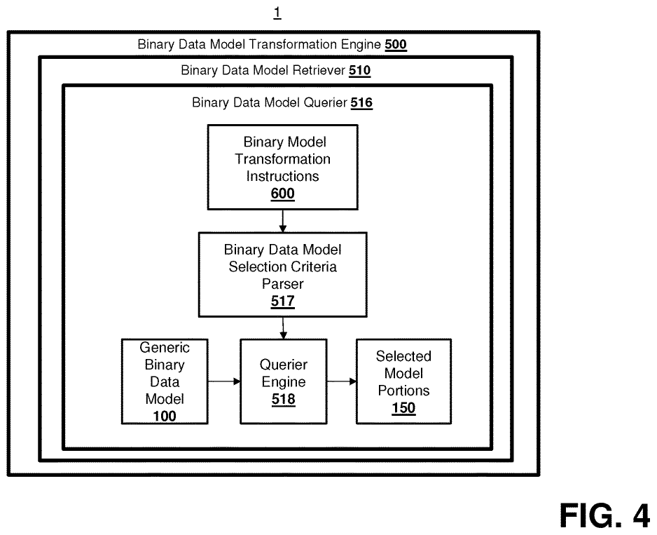

FIG. 4 illustrates a block diagram of a binary data model management system 1 that uses a binary data model querier 516 for identifying selected model portions based on descriptive characteristics of the model elements using search criteria 610 derived from the binary model transformation instructions 600.

As described herein, in embodiments, the binary data model querier 516 may be configured to search for binary data model elements using descriptive characteristics such as names, properties, binary type traits, or the like of the model elements. These descriptive characteristics of the binary data model elements may be queried based on a set of search criteria 610 derived from the binary model transformation instructions 600. In one or more embodiments, the set of search criteria 610 may further include a set of selection criteria that enable search of the generic binary data model 100 based on descriptive characteristics of the model elements. Accordingly, the set of selection criteria can be understood to be a subset of the set of search criteria 610.

More particularly, the binary data model selection criteria parser 517 may parse the binary model transformation instructions 600 to derive the search criteria 610 including the selection criteria. These selection criteria may be subsequently used by the querier engine 518 to produce the selected model portions 150. Example selection criteria may include:
All timestamp fields
All fields named “Price”
All session-level messages
Lookup of CancelID
Lookup of nasdaq.itch.addorder.price
All fields under namespace nasdaq.equities
All elements dependent on udp.header.messagecount

The querier engine 518 of the binary data model querier 516 may resolve the selection criteria derived from the binary model transformation instructions 600 into deterministic addresses within the generic binary data model 100. This process is not limited to textual matching, but refers to selection of model elements within the generic binary data model 100 based on resolved addresses and structural relationships defined by the selection criteria.

In one or more embodiments, the selection criteria derived from the binary model transformation instructions 600 may include logical expressions including conjunction, disjunction, negation, grouping, or other query operators, such that the set of selected model portions can be identified by evaluating the logical expressions against attributes of the set of model elements. The selection criteria may also include rules based on graph traversal through conceptual relationships, such as selecting all descendants of a message element, selecting all types referenced by a selected field, selecting all elements that depend on a particular enumeration, or selecting all elements related by a rule, such as all elements that appear in a repeated group.

For example:
Lookup(“CancelID”)
   may return an address such as:
/Protocol/Message[Type=X]/Field[CancelID]

In one or more embodiments, the querier engine 518 may be configured to support lookup of specific fields or types within binary data using addresses that incorporate implicit index resolution. For example, “packet.message[2]. price” may resolve to the Price field within the second message instance, where the index is either explicitly specified or implicitly derived from repetition rules. Implicit indexes may be addressable even when not explicitly present in the original specification.

Binary data model addresses enable reusable rule definitions, stable cross-version targeting, cross-protocol semantic type matching, and transformation instruction stability even if specification identifiers change. Because the querier engine 518 resolves address expressions into deterministic addresses, rule definitions may be stored and reapplied across model revisions without reliance on fragile textual matching.

In some embodiments, the querier engine 518 may be configured to translate human-generated or AI-generated selection criteria into model addresses by using an address parser and lookup engine. This enables grouping, inspection, reporting, UI visualization, dependency analysis, validation, namespace filtering, implicit element resolution, and address-based verification prior to any transformation.

The querier engine 518 produces a set of selected model portions 150 including model elements selected from the generic binary data model according to the selection criteria included in the search criteria 610 derived from the binary model transformation instructions. The resulting element list may be provided to other modules for subsequent transformation or manipulation operations.

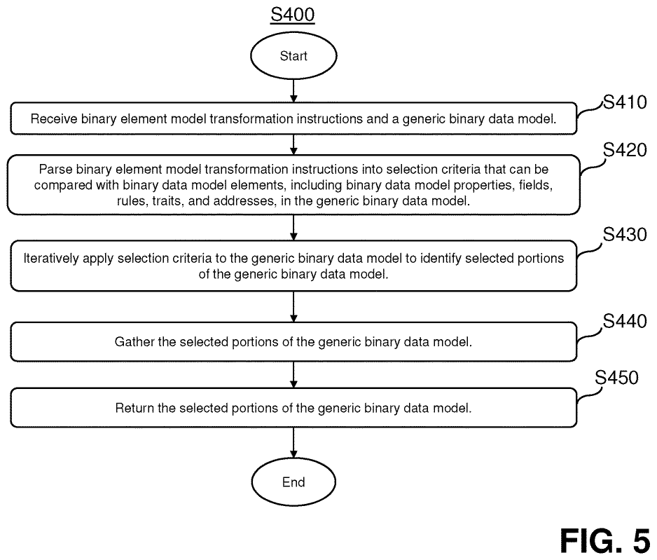

FIG. 5 illustrates a flowchart describing an example process S400 for selecting model portions from a generic binary data model 100 using a binary data model querier 516.

First, at Step S410, the process begins with the binary data model querier 516 receiving a set of binary model transformation instructions 600 together with a generic binary data model 100.

At Step S420, in one or more embodiments, the binary data model selection criteria parser 517 of the binary data model querier 516 parses the set of binary model transformation instructions 600 to derive selection criteria capable of being evaluated against model elements of the generic binary data model 100. Here, the selection criteria may reference binary data model properties, addresses, binary type traits, rules, or other attributes associated with model elements. The selection criteria derived by the binary data model selection criteria parser 517 can be understood to be a subset of the search criteria 610 described herein, and may include properties, fields, rules, traits, or addresses of the generic binary data model.

At Step S430, the querier engine 518 of the binary data model querier 516 iteratively applies the parsed selection criteria to model elements of the generic binary data model 100. During this process, candidate elements are evaluated against the conditions defined by the selection criteria.

At Step S440, for each model element that satisfies the selection criteria, the querier engine 518 of the binary data model querier 516 gathers candidate portions of the generic binary data model 100 including the identified model elements and records the association (e.g., the relationship) between each portion with its relevant selection category. This gathering process may accumulate multiple element sets corresponding to different subsets of the selection criteria.

At Step S450, after evaluation of all of the selection criteria and model elements, the querier engine 518 of the binary data model querier 516 returns the selected model portions 150 of the generic binary data model 100 as the output of the process S400.

In one or more embodiments, the binary data model retriever 510 uses the binary data model navigator 512 and the binary data model querier 516 to identify and retrieve selected model portions from the generic binary data model 100. The binary data model navigator 512, and the binary data model querier 516 are each implemented as modules within a larger collection of independent modules of the binary data model transformation engine 500.

In one or more embodiments, the modules of the binary data model transformation engine 500 are configured for independent implementation, replacement, addition, removal, or composition without requiring redesign of the transformation engine as a whole. Binary data model operation modules communicate via defined interfaces and exchange intermediate representations, including selected model elements, deterministic addresses, transformation instructions, and/or modified model portions. This modular architecture enables flexible configuration across protocols, transformation workflows, and generation targets, while supporting extensibility through incorporation of additional selection capabilities, transformation operations, or output integrations.

In one or more embodiments, downstream analyzers and target generators may invoke one or more modules of the transformation engine 500 to obtain intermediate representations tailored to specific processing tasks, including validation, inspection, dependency analysis, or code generation. In one or more embodiments, a target generator configured to produce a line-integrity monitoring program for a market data feed may invoke the binary data model querier 516 to identify all elements associated with packet or message sequencing and structural validation. In one or more embodiments, the querier 516 may evaluate selection criteria corresponding to packet sequence numbers, message counts, message lengths, and repetition rules, and may return deterministic addresses such as moldudp.header.sequencenumber, moldudp.header.messagecount, and packet.message.length. In one or more embodiments, these deterministic addresses may correspond to elements required for validating monotonic sequence progression, verifying message count consistency, and enforcing structural constraints during runtime processing.

In one or more embodiments, the target generator may further invoke the binary data model navigator 512 using the deterministic addresses returned by the binary data model querier 516 to retrieve ordered structural representations of the corresponding model elements, including dependency relationships. The retrieved binary data model elements may define sequence instructions whose execution order is coupled to the dependency structure of the binary data model, such that validation logic is applied in a sequence consistent with the underlying binary layout and repetition semantics. In one or more embodiments, where a binary message payload element includes a repeated group of branched messages governed by a message count field, the retrieved representations may define an iteration construct over the repeated message elements. The bounds and progression of the iteration construct may be derived from the repetition rules and dependency relationships expressed in the binary data model.

In one or more embodiments, the transformation engine 500 employs a modular operation architecture in which discrete transformation operations are encapsulated in independent operation modules. Each operation module defines one or more binary data model operations, including but not limited to selection, filtering, normalization, compaction, dependency resolution, annotation, or type refinement.

Binary data model operation modules may be invoked individually or composed into ordered execution pipelines, enabling reuse of operations across multiple workflows. In some embodiments, manipulation instructions reference operation modules by module identifier, allowing the binary data model manipulator 520 to dynamically apply predefined transformation behaviors to selected model portions without requiring inline specification of transformation logic. In one or more embodiments, the transformation engine 500 may comprise one such ordered execution pipeline, in which multiple operation modules are composed to perform coordinated selection, retrieval, and modification of binary data model elements in accordance with defined transformation workflows. In one or more embodiments, the binary data model retriever 510 may comprise another such ordered execution pipeline, in which one or more operation modules, including the binary data model navigator 512 and binary data model querier 516, are composed to obtain intermediate representations of binary data model elements responsive to specified selection criteria. In one or more embodiments, these pipelines may be defined, extended, or reconfigured by referencing operation modules by identifier, thereby enabling reuse of module behavior across distinct transformation, analysis, or generation contexts.

Binary data model operation modules operate on independent intermediate representations, including selected model portions, normalized trait representations, or partially transformed models, and produce outputs consumable by subsequent modules. This approach enables composition of operations through chaining of modular operations.

In one or more embodiments, the binary data model management system 1 further includes a binary data model qualifier module 521 configured to perform type trait inference over binary data model elements by evaluating type trait predicates based on structural relationships, binary data model values, characteristics, and dependencies within the generic binary data model 100. The binary data model qualifier module 521 may evaluate whether a model element or group of elements satisfies a defined binary data model element characteristic or trait predicate and, upon satisfaction, associate the corresponding property, characteristic or trait with the element as an addressable property or as a queryable value when requested. The binary data model qualifier module 521 may operate on individual elements or on collections of elements and may evaluate conditions including, but not limited to, size, alignment, contiguity, dependency structure, or encoding characteristics. Example binary type traits may include determinations such as whether an element is blittable, fixed-length, alignment-compatible, or conditionally dependent on runtime values. Type trait inference may be performed over individual elements or collections of elements based on their structural configuration within the model, including cross-element relationships and binary data interpretation logic that are not expressible as intrinsic properties of a single type definition.

In one or more embodiments, the binary data model qualifier module 521 may infer derived binary type traits as emergent properties of the binary data model rather than relying on explicit specification-level annotations. For example, a blittability operation may evaluate whether a sequence of fields forms a contiguous region of memory with consistent alignment and without intervening variable-length dependencies, thereby enabling direct memory transfer or reinterpretation without transformation. The resulting binary model element type trait may be returned when requested or stored as a normalized attribute associated with the corresponding model element or group of elements and may be deterministically addressable within the binary data model.

In one or more embodiments, the binary data model management system 1 further includes a binary data model calculator module 522 configured to compute quantitative or structural properties of binary data model elements based on traversal of the model and evaluation of dependency relationships. The binary data model calculator module 522 may depend on any of: the navigation engine, the binary data model querier, qualifier module, and structural or semantic relationships described in a binary data model or portion thereof. The binary data model calculator module 522 may determine properties including, but not limited to, total byte size, bit width, relative or absolute offset, repetition-expanded size, dependency depth, or structural span across multiple elements. These computed values may be associated with elements as computed properties or derived binary type traits and may be returned or stored in intermediate representations such as offset tables, size tables, or structural indices.

In one or more embodiments, the binary data model calculator module 522 operates in conjunction with the binary data model qualifier module 521, such that computed quantitative properties are used as inputs to binary data model element type trait determination. For example, the binary data model calculator module 522 may compute the total byte length of a repeated message block, and the binary data model qualifier module 521 may subsequently evaluate whether the resulting structure satisfies conditions for fixed-length segmentation or vectorized processing. Similarly, the binary data model calculator module 522 may determine whether a set of elements forms a contiguous memory region, and the binary data model qualifier module 521 may return or assign a blittable type trait based on the absence of structural discontinuities or variable-length dependencies. These are only some examples of a large number of computed properties that the binary data model calculator module 522 can produce.

In one or more embodiments, the derived traits and computed properties produced by the binary data model qualifier module 521 and binary data model calculator module 522 are incorporated into the set of normalized properties of the binary data model elements and are returned to a calling module or made available to downstream components. These properties may be consumed by the binary data model querier 516, the binary data model navigator 512, or downstream transformation and other binary data operation modules or downstream target generators.

For example, the binary data model calculator module 522 contains an operation known as offset resolution, configured to compute relative and absolute offsets between entities within the binary data model. Offset resolution traverses parent-child relationships within the model and accumulates positional information to determine byte-level or bit-level offsets. Absolute offsets may be resolved with respect to a fixed origin within a containing structure, such as a message or packet boundary, while relative offsets may be expressed with respect to other elements or intermediate positions within the model. The distinction between relative and absolute offsets is significant in the presence of variable-length elements, conditional fields, or repetition-dependent structures, where the position of downstream elements cannot be determined as a fixed absolute value independent of runtime or structural context. In such cases, relative offsets enable representation of positional relationships that remain valid under variation in preceding element size or multiplicity, thereby preserving correctness of layout computation and enabling dependency-aware traversal, validation, and code generation.

In one or more embodiments the computed offsets are returned when requested or stored in a relative offset table comprising entries that associate pairs of entities with corresponding offset values and validity indicators. These offset relationships enable downstream components to reason about memory layout, grouping of contiguous regions, and ordering of data elements without requiring repeated traversal of the model structure. These values are examples of derived properties.

In one or more embodiments, the binary data model calculator module 522 of the binary data model management system 1 computes structural depth for entities within the binary data model. A depth computation operation traverses the model graph and assigns a depth value to each entity based on its position within the hierarchy. Computed depth values may be returned as requested or stored in a depth index table that enables retrieval of entities by structural level. These values are examples of derived properties.

In one or more embodiments, the binary data model querier 516 is configured to evaluate selection criteria that reference both intrinsic properties and derived properties produced by the binary data model qualifier module 521 and the binary data model calculator module 522. For example, selection criteria may include trait predicates such as identifying all elements with a blittable property, all message structures exceeding a specified byte size threshold, all elements forming contiguous segments above a defined length, or all elements whose computed dependency depth exceeds a threshold. Because the derived traits and computed properties are deterministically associated with model elements, such queries may be resolved into stable addresses independent of specification-level variation. As used herein, “trait predicates” refer to boolean-valued functions or assertions used to evaluate whether a specific type or data instance satisfies certain behavioral or structural requirements.

In one or more embodiments, the binary data model qualifier module 521 and the binary data model calculator module 522 operate as composable binary data model operation modules within the transformation engine 500, enabling repeated evaluation and reuse across multiple transformation workflows. The derived traits and computed properties may be recomputed upon modification of the binary data model and may be propagated through various independent intermediate representations to ensure consistency with the current structural state of the model. This approach enables downstream components to reason about both structural and emergent properties of the characteristics of the binary data model without requiring recomputation or manual annotation.

Binary data model operation modules collectively form a callable operation layer that is decoupled from navigation and selection. This separation enables deterministic reuse of transformation logic across multiple binary data models and across successive derivations of a binary data model, while preserving consistency of transformation behavior independent of the specific selection mechanism used to obtain input elements.

In one or more embodiments, the binary data model transformation engine 500 is configured to operate on a plurality of generic binary data models. Generic binary data models may be aggregated into a model library, wherein each generic binary data model represents a distinct protocol, protocol version, market, asset class, or data processing domain. The model library may comprise a collection of independently addressable binary data models stored in a shared namespace or registry, with each model retaining its internal deterministic addressing scheme while also being associated with library-level identifiers, metadata, and classification attributes. The library structure enables shared access to model elements across multiple binary data models without requiring prior consolidation into a single hierarchical model.

In one or more embodiments, the binary data model querier 516 is configured to operate over the model library by evaluating selection criteria across the plurality of generic binary data models. The querier 516 may interpret selection criteria that reference library-level attributes, model-level namespaces, or cross-model semantic traits, and may return selected model portions comprising elements drawn from multiple binary data models within the library. The resulting selected model portions may include deterministic addresses that are qualified by their originating model context, thereby preserving uniqueness while enabling aggregation.

In one or more embodiments, the selection criteria may include conditions that span multiple binary data models, including identification of elements sharing semantic classifications, trait assignments, structural roles, or derived properties produced by the binary data model qualifier module 521 and binary data model calculator module 522. The binary data model querier 516 may evaluate such criteria by iterating over each binary data model in the library or by using indexed representations of model attributes, thereby producing a unified result set that represents logically related elements across otherwise independent protocol definitions.

This library-based querying mechanism enables the binary data model management system 1 to access multiple binary data models as a cohesive queryable space while preserving the structural integrity and independence of each underlying model. As a result, downstream components may operate on aggregated model portions that represent cross-protocol or cross-domain concepts, including normalized message classes, shared field types, or semantically equivalent structures across different markets or protocol families.

In one or more embodiments, the binary data model querier 516 may be configured to evaluate selection criteria that identify semantically related elements across multiple binary data models within the model library. For example, a selection criterion may request identification of all instrument-related message elements within binary data models corresponding to U.S. equities markets. Such a selection criterion may be expressed programmatically, declaratively, or via a natural language interface, and may be interpreted by the binary data model selection criteria parser 517 to derive search criteria 610 including conditions on model metadata, namespaces, semantic classifications, and derived traits. The querier engine 518 may evaluate these criteria across a plurality of binary data models in the library, including models representing multiple exchanges, protocol versions, or feed types, and may identify message elements corresponding to instrument definitions, instrument state updates, or instrument reference data.

In one or more embodiments, the querier engine 518 may use the binary data model qualifier module 521 and binary data model calculator module 522 to refine the selection, such that instrument-related messages are identified not only by naming conventions but also by structural and semantic characteristics, including presence of instrument identifier fields, dependency relationships to instrument reference tables, or derived traits indicating instrument scope. The resulting selected model portions may include deterministic addresses qualified by their originating binary data model, such as nasdaq.equities.itch.instrumentdefinition, nyse.equities.pillar.instrumentupdate, or other semantically equivalent message elements across different protocols.

In one or more embodiments, the selection criteria may be generated by an artificial intelligence system that produces structured query expressions corresponding to a user request, such as “identify all instrument messages in U.S. equities markets.” The binary data model querier 516 may translate such expressions into formal selection criteria and evaluate them deterministically against the model library, thereby producing a stable and reproducible set of model elements corresponding to the requested concept. The resulting aggregated model portions may be provided to downstream components for further manipulation, normalization, or code generation, enabling construction of cross-protocol systems that operate on unified semantic categories derived from multiple independent binary data models.

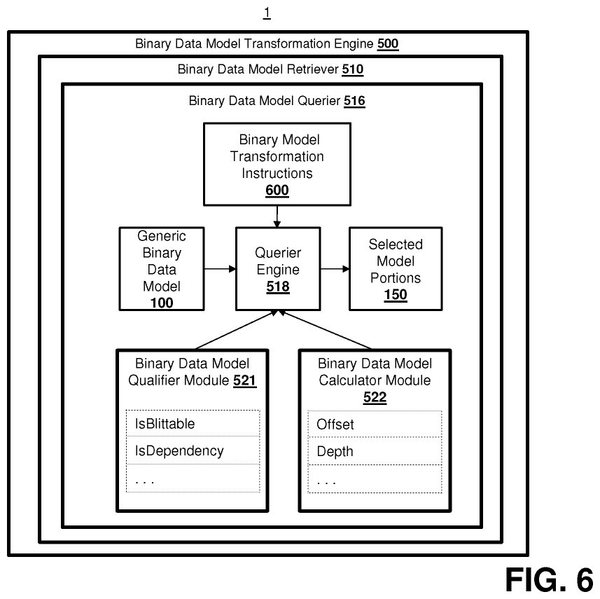

FIG. 6 illustrates an embodiment of a binary data model querier 516 configured to identify selected model portions 150 of a generic binary data model 100 based on binary model transformation instructions 600.

In the embodiment shown, the binary data model querier 516 receives the generic binary data model 100 together with the binary model transformation instructions 600. The binary data model querier 516 includes a querier engine 518 configured to evaluate selection criteria derived from the transformation instructions and to identify model elements within the generic binary data model 100 that satisfy the selection criteria.

In one or more embodiments, the binary data model querier 516 further includes a data model qualifier module 521 and a binary data model calculator module 522. The binary data model qualifier module 521 is configured to evaluate binary type trait predicates over binary data model elements based on structural relationships, binary data model values, characteristics, and dependencies within the generic binary data model 100. Example binary type traits may include properties such as blittable, dependency-based, or other structural or semantic classifications.

In one or more embodiments, the binary data model calculator module 522 is configured to compute quantitative or structural properties of binary data model elements. The binary data model calculator module 522 may determine properties including, but not limited to, offsets, lengths, sizes, or other derived structural characteristics. These computed properties may be used as inputs to the binary data model qualifier module 521 or may be directly referenced by the querier engine 518 when evaluating selection criteria.

In one or more embodiments, the querier engine 518 evaluates selection criteria that reference intrinsic properties of model elements, derived properties computed by the binary data model calculator module 522, and type traits evaluated by the binary data model qualifier module 521. The querier engine 518 may iteratively evaluate model elements within the generic binary data model 100 and identify those elements that satisfy the selection criteria.

The binary data model querier 516 produces a set of selected model portions 150 comprising model elements identified within the generic binary data model 100. The selected model portions 150 may include deterministic addresses corresponding to the identified model elements and may be provided to downstream modules for further transformation, manipulation, or analysis.

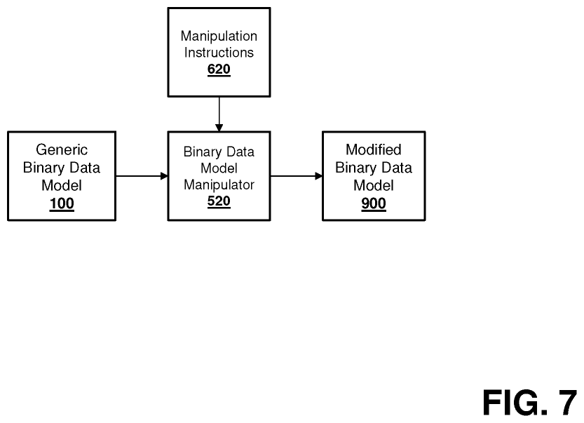

FIG. 7 illustrates a binary data model manipulator 520 configured to transform a generic binary data model 100 into a modified binary data model 900 based on manipulation instructions 620. In the embodiment shown, the binary data model manipulator 520 receives the manipulation instructions 620 as part of the binary data model transformation instructions 600 together with the generic binary data model 100.

In one or more embodiments, the manipulation instructions 620 may specify structural or semantic modifications to be applied to elements within the generic binary data model 100. The manipulation instructions 620 may define manipulations describing adding elements (e.g., adding derived model elements, splitting elements), removing elements (e.g., combining model elements), modifying attributes (e.g., editing attribute values, renaming a model element, rewriting a dependency, propagating metadata), rearranging elements (e.g., rearranging a sequence of elements), or modifying dependencies. In some embodiments, the manipulation operations may include injecting, by the binary data model manipulator 520, at least one derived model element representing at least one of a derived offset, derived length, derived index, derived type name, or derived semantic field. In this case, the binary data model manipulator 520 combining the set of transformed portions may include incorporating the derived model element into the modified binary data model 900.

In embodiments, the manipulation instructions 620 may define the manipulation operations with respect to a set of selection categories. The set of selection categories may include message-level elements, header elements, payload elements, timestamp elements, instrument identifier elements, enumeration elements, or field-level elements of the generic binary data model 100. For example, the manipulation instructions 620 may define particular manipulation operations for use with respect to particular selection categories.

The binary data model manipulator 520 applies the manipulation instructions 620 to the generic binary data model 100 to produce a modified binary data model 900. The binary data model manipulator 520 may perform transformations directly on selected elements or may operate on groups of elements identified through the previously described navigation or querying operations. The binary data model manipulator 520 may apply different manipulation operations to different groups.

In one or more embodiments, the binary data model manipulator 520 may use the binary data model navigator 512, the binary data model querier 516, or both to identify elements, features, or relationships that are necessary to do the calculations required to fulfill the requirements of the manipulation instructions 620.

The modified binary data model 900 represents a modified independent intermediate representation of the original generic binary data model 100. The modified binary data model 900 may preserve structural relationships while incorporating the modifications specified by the manipulation instructions. This allows different sets of manipulation instructions to apply in different orders and ensures the modularity of potential transformations.

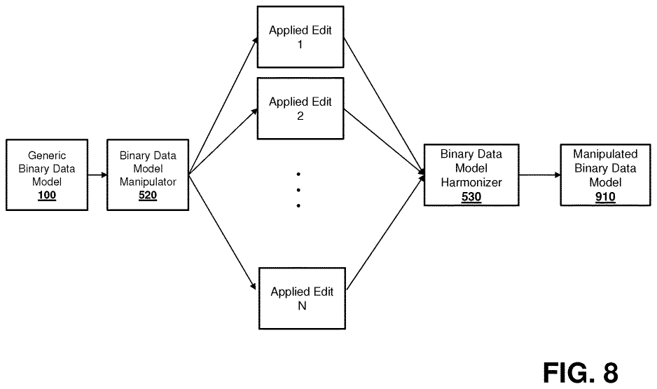

FIG. 8 illustrates a binary data model manipulator 520 configured to apply manipulations to a generic binary data model 100 using a binary data model manipulator 520 and a binary data model harmonizer 530 configured to verify that the sequential fields and dependencies of the modified binary data model are valid. In the embodiment shown in FIG. 8, the binary data model harmonizer 530 receives the generic binary data model 100 after a set of applied edits are performed by the binary data model manipulator 520.

As shown in FIG. 8, in one or more embodiments, the binary data model manipulator 520 applies a sequence of edits to elements within the generic binary data model 100. Each edit may modify structural relationships, attributes, or dependencies associated with model elements. By applying these edits to the generic binary data model 100, the binary data model manipulator 520 produces a modified binary data model 900 representing the cumulative result of the applied edits.

In one or more embodiments, aspects of the disclosure relate to the recognition that, because edits to the generic binary data model 100 may introduce conflicts such as inconsistencies or unresolved dependencies (collectively referred to herein as “conflicts”), it may be desirable to incorporate functionality for identifying and resolving such conflicts. Accordingly, in embodiments, the binary data model transformation engine 500 according to the embodiments of the present disclosure additionally includes a binary data model harmonizer 530 configured to resolve dependencies, reconcile structural relationships, and normalize the modified binary data model 900 after application of the edits to generate a manipulated binary data model 910. The binary data model harmonizer 530 may update dependency references or ensure structural consistency across elements. The binary data model harmonizer 530 verifies the manipulated binary data model 910 represents a structurally consistent representation of the modified model following application of the edits.

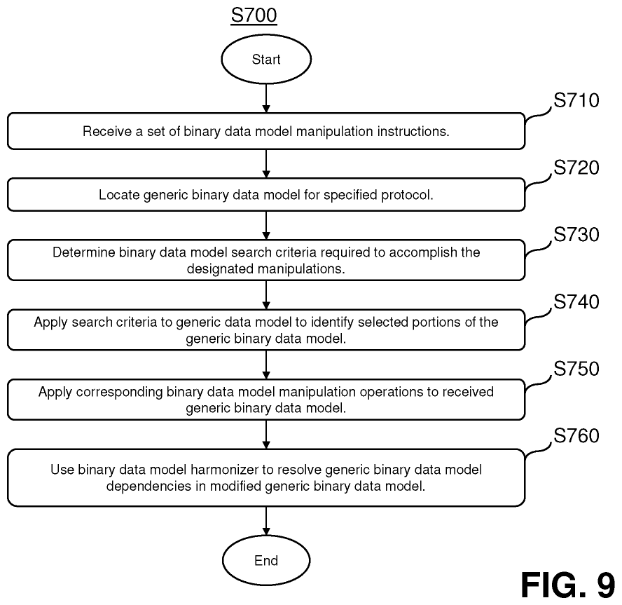

FIG. 9 illustrates a flowchart S700 describing an example manipulation process performed by the binary data model manipulator 520 and the binary data model harmonizer 530.

The process begins at Step S710 when the binary data model manipulator 520 receives a set of binary data model manipulation instructions 620. As described herein, the set of binary data model manipulation instructions 620 may be received as part of the binary data model transformation instructions 600 provided as an input to the binary data model transformation engine 500.

At Step S720, in one or more embodiments, the binary data model manipulator 520 locates the generic binary data model 100 or models corresponding to the protocol(s) or binary model elements to be manipulated. At Step S730, the binary data model manipulator 520 then determines the search criteria 610 required to identify the portions of the generic binary data model 100 affected by the manipulation instructions 620. In one or more embodiments, the binary data model manipulator 520 may determine the search criteria 610 by calling the binary data model navigator 512 or the binary data model querier 516 to parse the binary data model transformation instructions 600 to derive the search criteria 610. In certain embodiments, the search criteria 610 may be specified by the manipulation instructions 620, such that the binary data model manipulator 520 can extract the search criteria 610 directly from the manipulation instructions 620.

At Step S740, the binary data model manipulator 520 may apply the search criteria 610 to the generic binary data model 100 to identify selected model portions of the model that are subject to modification. These portions may correspond to specific elements or groups of elements. Here too, the binary data model manipulator 520 may identify the selected model portions of the generic binary data model 100 by calling the binary data model navigator 512 or the binary data model querier 516 to search the generic binary data model 100 for selected portions that satisfy the search criteria, as described above with respect to FIGS. 2, 3, 4, and 5.

At Step S750, after identifying the selected model portions, the binary data model manipulator 520 applies the corresponding manipulation operations to the received generic binary data model 100. These operations modify structural relationships, attributes, or dependencies of the selected model elements.

At Step S760, following application of the manipulation operations, the binary data model manipulator 520 may optionally use the binary data model harmonizer 530 to resolve dependencies within the modified generic binary model 900 to generate a manipulated generic binary model 910. The binary data model harmonizer 530 ensures that the resulting manipulated generic binary model 910 remains structurally consistent.

The process then ends with the modified binary data model 900 or manipulated generic binary model 910 representing the result of the applied manipulations being output as the result of the process S700.

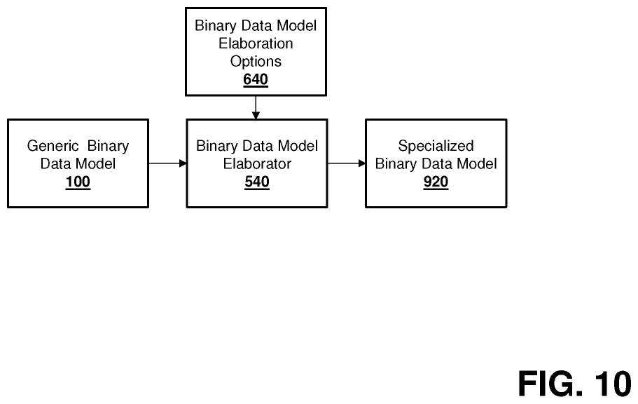

FIG. 10 illustrates a binary data model elaborator 540 configured to produce a specialized binary data model 920 from a generic binary data model 100 using elaboration options 640. In the embodiment shown, the binary data model elaborator 540 receives a generic binary data model 100 together with elaboration options 640.

In one or more embodiments, the elaboration options 640 specify additional transformation or normalization rules to be applied to the generic binary data model 100. These options may include operations such as type normalization, optimization, structural annotation, dependency expansion, or derived attribute generation. The elaboration options 640 may facilitate specialization of the generic binary data model 100 for a particular task or target. In embodiments, the elaboration options 640 may be included in the binary data model transformation instructions 600 input to the binary data model transformation engine 500.

In one or more embodiments, the binary data model elaborator 540 may recombine the selected model portions of the modified binary data model 900 elements to generate the specialized binary data model 920. The specialized binary data model 920 may preserve a consistent internal representation and may include updated identifiers, updated ordered lists, updated dependency edges, and updated layout properties. The specialized binary data model 920 may be stored as a standalone artifact, transmitted to other computing systems, or used as an input to one or more target programming language source code generators.

In one or more embodiments, the specialized binary data model 920 is usable to generate executable programs, intermediate representations, target source generation source code, or other derived artifacts that act on binary data described by the model. Such generated artifacts may include parsers, decoders, encoders, protocol analyzers, packet capture inspection tools, header extraction programs, compression pipelines, storage format converters, analytics pipelines, user interfaces, or hardware configurations. For example, the specialized binary data model 920 may be used to generate a program that processes only a subset of message types, a program that extracts only header fields, a program that converts binary messages into a columnar storage format, or a program that performs line-integrity validation of a binary feed.

In one or more embodiments, the binary data model transformation engine 500 according to the present disclosure may generate an intermediate representation optimized for downstream compilation. The intermediate representation may include linearized field layouts, canonicalized type representations, normalized naming, or derived structural indices that accelerate runtime parsing or enable efficient code generation in one or more target languages. The intermediate representation may be produced from the specialized binary data model and may be consumed by generators for producing code in C, C++, Rust, Java, C#, Python, Verilog, or any other suitable output format.

In one or more embodiments, the binary data model transformation engine 500 supports composition of multiple protocol models into a combined binary data model. For example, the generic binary data model 100 may include elements representing Ethernet headers, IPv4 headers, UDP headers, and an application-layer protocol such as ITCH. The binary data model retriever 510 may select elements across these multiple layers, and the binary data model manipulator 520 may reorganize, merge, or normalize them into a unified packet model. Such a combined model may be used to generate a unified parser or analytics system that operates across multiple protocol layers. Particularly, when a generic binary data model 100 that represents a plurality of protocol layers is stored in the memory, the binary data model retriever 510 may identify protocol-layer model elements of the set of model elements from at least two protocol layers of the plurality of protocol layers, and generate the modified binary data model 900 by combining the protocol-layer model elements into a unified model representing the plurality of protocol layers. Here, the protocol-layer model elements refer to model elements of the generic binary data model that represent fields, structures, rules, dependencies, or metadata associated with a particular protocol layer within a multi-layer protocol stack.

In one or more embodiments, the binary data model transformation engine 500 is configured to support iterative refinement, wherein selection and manipulation operations are repeatedly applied to derive progressively specialized models. For example, a first transformation may remove unused messages, a second transformation may normalize type names, a third transformation may inject derived timestamp fields, and a fourth transformation may generate a reduced model suitable for compression. The binary data model transformation engine 500 may store intermediate specialized models and may allow versioning and comparison of modifications.

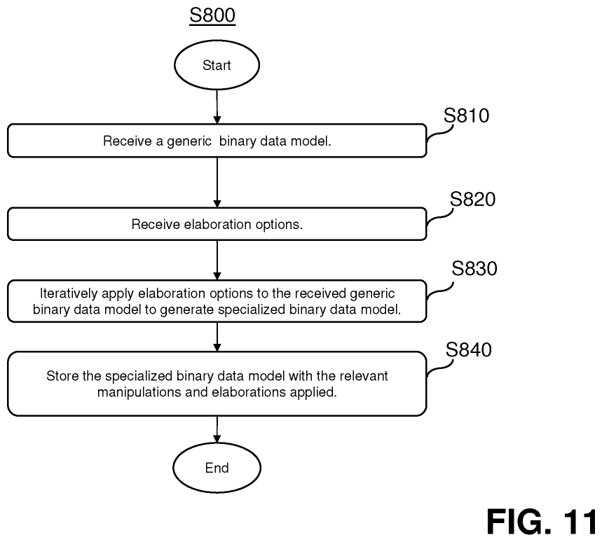

FIG. 11 illustrates a binary data model elaborator flowchart detailing a process S800 of receiving one or more generic binary data models for one or more specified protocols, receiving elaboration options, iteratively applying the elaboration options to generate a specialized binary data model 920, and storing the specialized binary data model 920.

At Step S810, the generic binary data model elaborator 540 receives a generic binary data model 100.

At Step S820, the generic binary data model elaborator 540 receives elaboration options 640. In one or more embodiments, the elaboration options 640 may designate linearizing the model in a canonical order, regenerating offsets or layout constraints, validating dependency consistency, and assigning updated identifiers. The elaboration options 640 may be received as part of the binary data model transformation instructions 600 input to the binary data model transformation engine 500.

At Step S830, in one or more embodiments, the generic binary data model elaborator 540 iteratively applies the elaboration options 640 to the received binary data model 100 to generate a specialized binary data model 920. Each iteration may introduce modifications such as structural normalization or derivation of additional model elements. The elaboration process may update structural attributes, relationships, or metadata associated with elements of the model. Intermediate results may be stored during successive iterations.

At Step S840, after the elaboration options 640 have been applied, the generic binary data model elaborator 540 stores the specialized binary data model 920 with the relevant manipulations and elaborations applied.

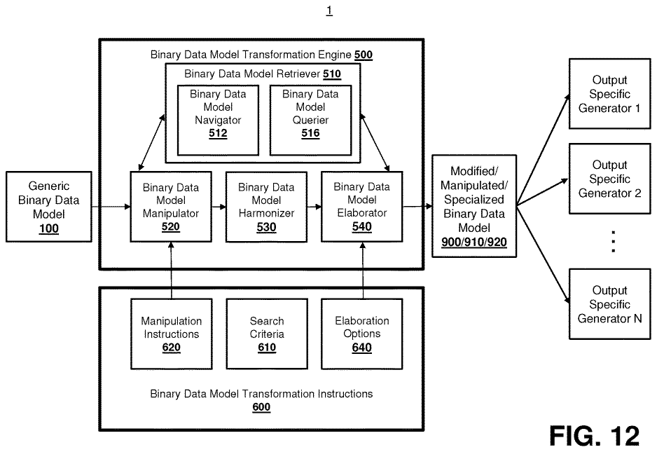

FIG. 12 illustrates a binary data model transformation engine 500 comprising multiple binary data model components that operate on a generic binary data model 100 to produce a modified binary data model 900, manipulated binary data model 910, or specialized binary data model 920. In the embodiment shown, the binary data model transformation engine 500 receives a generic binary data model 100 together with binary data model transformation instructions 600.

In one or more embodiments, the binary data model transformation engine 500 includes a binary data model retriever 510, a binary data model manipulator 520, a binary data model harmonizer 530, and a binary data model elaborator 540. The binary data model retriever 510 may further include a binary data model navigator 512 and a binary data model querier 516. These components operate in coordination to apply selection, manipulation, and elaboration operations to the generic binary data model 100.

The binary data model retriever 510 may use the binary data model navigator 512 and/or the binary data model querier 516 to identify elements within the generic binary data model 100 according to search criteria 610 derived from the binary data model transformation instructions 600, which also includes manipulation instructions 620 and elaboration options 640. The binary data model manipulator 520 applies structural transformations to the identified elements. The binary data model harmonizer 530 may resolve dependencies and ensure structural consistency in the modified binary data model 900 following manipulation to generate a manipulated binary data model 910.

In one or more embodiments, one or more of the binary data model navigator 512 and/or the binary data model querier 516 may be used by binary data model manipulator 520 and/or the binary data model elaborator 540 to perform their respective functions as described herein.

The binary data model elaborator 540 may apply additional elaboration options 640 to the modified binary data model 900 to produce a specialized binary data model 920. The specialized binary data model 920 may then be provided to one or more target output specific generators. In one or more embodiments, multiple output specific generators receive the specialized binary data model 920 and generate artifacts tailored to different targets. These generators may produce code, specialized intermediate representations, or other output artifacts derived from the specialized model.

It will be understood herein that the binary data model transformation engine 500 is capable of outputting any of the modified binary data model 900, the manipulated binary data model 910, and/or the specialized binary data model 920 depending on the operations designated by the binary data model transformation instructions 600. Thus, for convenience of description, it will be understood that reference to generation, output, or usage of the modified binary data model 900 can also be construed to cover programming language source code generation, output, or usage of the manipulated binary data model 910, and/or the specialized binary data model 920.

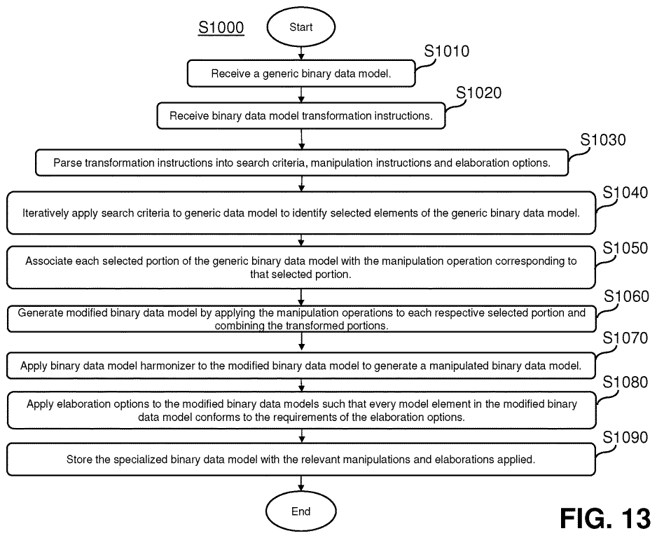

FIG. 13 illustrates a flowchart describing an end-to-end process S1000 performed by the binary data model transformation engine 500.

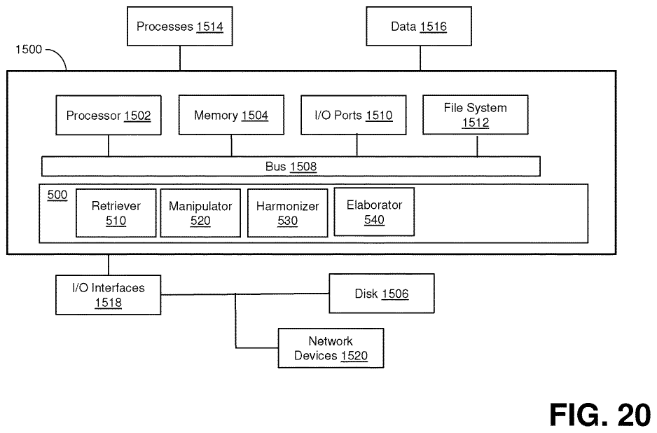

At Step S1010 and Step S1020, the process S1000 begins with the binary data model transformation engine 500 receiving a generic binary data model 100 together with binary data model transformation instructions 600, and storing the received generic binary data model 100 and the binary data model transformation instructions 600 in memory (e.g., memory 1504 of the computing device 1500 shown in FIG. 20).

At Step S1030, in one or more embodiments, the binary data model retriever 510 parses the binary data model transformation instructions 600 to extract search criteria 610, manipulation instructions 620, and elaboration options 640. These components collectively define the transformations to be applied to specific portions of the generic binary data model 100. Particularly, the search criteria 610 refer to conditions (such as name, attribute, trait, relationship, or address-based conditions) used by the computing system to identify and select model elements within the generic binary data model 100. In embodiments, as described herein, the search criteria 610 may include address search parameters usable by the binary data model navigator 512 to identify selected model portions based on address information and selection criteria usable by the binary data model querier 516 to identify selective model portions based on descriptive characteristics of model elements. The manipulation instructions 620 may define a) selection categories that classify the set of model elements into one or more groups and b) manipulation operations associated with the selection categories. The elaboration options 640 may specify one or more requirements for the modified binary data model 900.

At Step S1040, the binary data model retriever 510 iteratively applies the search criteria 610 to the generic binary data model 100 to identify selected model portions that include model elements that match the search criteria. These selected model portions represent portions of the generic binary data model 100 targeted for modification.

At Step S1050, for each selected model portion of the model, the binary data model manipulator 520 associates a manipulation operation defined by the manipulation instructions 620. The manipulation operations are applied to the selected model portions to modify structural relationships, attributes, or dependencies. Specifically, the binary data model manipulator 520 may store manipulation operations corresponding to selection categories of the respective model portions in association with each selected model portion in memory.

At Step S1060, the binary model manipulator 520 generates a set of transformed binary data model portions by applying the associated manipulation operations to respective selected model portions in the memory and combining the set of transformed portions into the modified binary data model 900. As described herein, the modified binary data model 900 may be usable at least to generate programming language source code (e.g., a software program that operates using a binary protocol).

At Step S1070, the binary data model harmonizer 530 may be applied to the modified binary data model 900 to ensure that dependencies and structural relationships are consistent following manipulation, thereby generating a manipulated binary data model 910.

At Step S1080, the binary data model elaborator 540 may then apply elaboration options 640 to the modified binary data model 900 or the manipulated binary data model 910 to ensure that each model element therein conforms to requirements specified by the elaboration options 640, thereby generating a specialized binary data model 920.

At Step S1090, after completion of the operations described above, binary data model transformation engine 500 stores the modified binary data model 900, the manipulated binary data model 910, and/or the specialized binary data model 920 produced by the process S1000 in memory.

In one or more embodiments, a plurality of binary data model targets may be supported, wherein each target corresponds to a distinct class of downstream processing system or output artifact. While the generic binary data model preserves a complete representation of the sequential and dependency relationships required for general-purpose binary model code generation, certain targets benefit from specialized binary data models that are adapted to the structural, performance, or semantic requirements of the target. Such specialization may include reorganization of elements, derivation of additional attributes, normalization of representations, or elimination of structures not required by the target. The binary data model elaborator 540 is configured to apply such specialization operations to produce target-specific binary data models that retain consistency with the original model while being optimized for the intended downstream use. The following examples illustrate representative forms of binary data model elaboration, although additional forms may be applied without limitation.

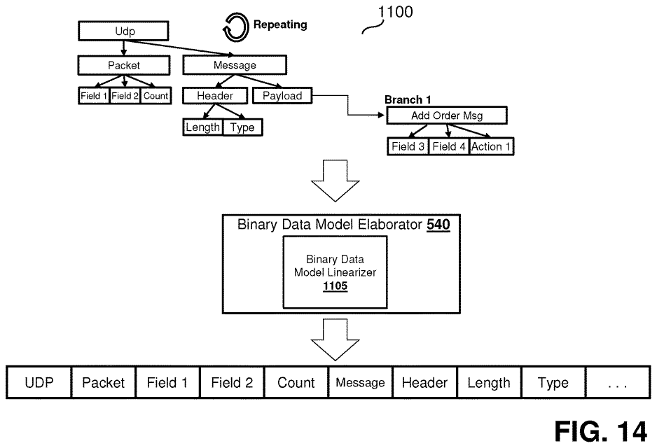

Referring to FIG. 14, in one or more embodiments, a generic binary data model, illustrated in a tree form, may be linearized using the linearization methods of the binary data model elaborator 540, resulting in a sequential data structure.

Generic binary data models contain trees of binary data model elements that describe the sequential and dependency relationships between these elements which are inherently hierarchical or graph-based. However some target generations benefit from a linearization process producing a parallel ordered list of binary data model elements that corresponds to the same physical sequence.

In one or more embodiments, the binary data model elaborator 540 comprises a plurality of elaboration operations configurable to transform a generic or modified binary data model into a specialized binary data model adapted for a particular downstream target. Such elaboration operations may be selectively enabled or parameterized in a manner analogous to compiler configuration options, thereby allowing systematic variation of the resulting model without altering the underlying generic binary data model.

In one or more embodiments, the binary data model elaborator 540 can be configured using the range of transformation capabilities of the binary data model transformation engine 500 to directly output computer source code that can be used to process a binary data for transmission, reception, or storage. The binary data model elaborator 540 can be configured using the range of transformation capabilities of the binary data model transformation engine 500 to perform further actions that may include, evaluation of validation conditions, construction of intermediate data structures, aggregation of metrics, emission of events, or execution of user-defined operations associated with model elements.

In one or more embodiments, as shown in FIG. 14, the binary data model elaborator 540 includes a binary data model linearizer 1105 configured to transform a hierarchical binary data model 1100 into a linear intermediate representation 1110. The binary data model linearizer 1105 traverses the hierarchical structure of binary data model elements and produces an ordered sequence of elements while preserving the sequential ordering and dependency relationships defined within the model. In this manner, the resulting linear representation 1110 retains semantic equivalence with the hierarchical binary data model 1100 while providing a structure suitable for downstream targets that operate on sequential or index-based representations.

For example, a hierarchical structure:
UDP Packet
   Header
   Session
   SequenceNumber
   MessageCount
Repeating MessageBlock
   Length
   MessageData
      may be transformed into a linear intermediate representation 1110 in which header fields are emitted first, followed by loop constructs derived from the repetition rule, followed by data fields. In embodiments, the binary data model linearizer 1105 may generate the linear intermediate representation 1110 by executing a linearization operation.

In one or more embodiments, a linearized binary data model may be transformed into a reverse linearized representation. The reverse linearized representation orders binary data model elements in a specific dependency sequence such that elements upon which other elements depend are positioned earlier in the sequence. This ordering may be suitable for downstream targets that require declaration or instantiation of dependent structures prior to their use.

In particular, in some statically compiled programming languages such as C++, type definitions, struct layouts, template instantiations, and other compile-time constructs must be declared prior to being referenced by dependent constructs. For example, a struct that contains a field of another struct type requires that the referenced struct be defined before the containing struct is compiled. Similarly, template instantiations and inline functions may require that all dependent types and constants be available at the point of instantiation. The reverse linearized representation enables generation of such constructs by ordering binary data model elements in a manner consistent with these compile-time dependency constraints, thereby avoiding forward-reference errors and enabling correct compilation without requiring manual reordering or forward declarations.

In one or more embodiments, the binary data model management system 1 further includes a binary data model element iterator configured to traverse the binary data model according to a selectable traversal strategy, wherein the traversal order defines the sequence of execution of associated operations. The binary data model element iterator is capable of operating as an execution mechanism over the binary data model rather than solely as a transformation producing a new model, and may generate outputs including instruction sequences, runtime evaluators, validation logic, or analysis results derived from the structure and semantics of the binary data model.

In one or more embodiments, the binary data model element iterator is configured to invoke element-specific operations during traversal, wherein operations may be associated with binary data model elements, element types, or type traits, and may be executed upon visiting an element, prior to traversal of child elements, subsequent to traversal of child elements, or upon satisfaction of dependency conditions. Traversal may further be dependency-aware, such that execution of operations associated with a given element is ordered after execution of operations associated with elements on which the given element depends, thereby producing execution sequences consistent with both structural hierarchy and dependency relationships of the binary data model. The binary data model iterator may use the linearized or the reverse linearized elaboration of the binary data model for ordered element iteration.

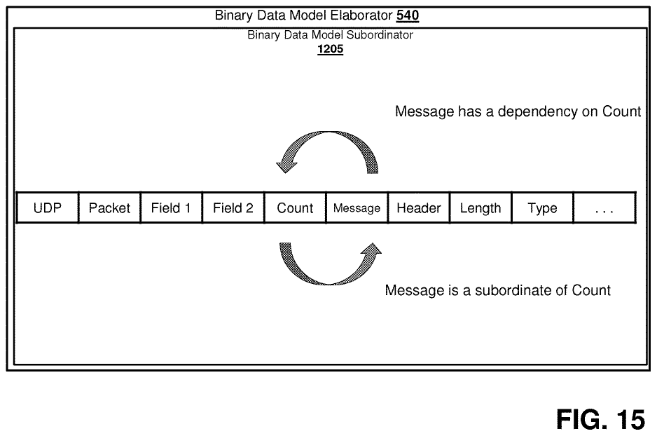

FIG. 15 is a schematic diagram of an embodiment for identifying and annotating dependency relationships between elements of a binary data model and generating dependency-aware ordering information. In one or more embodiments, the binary data model elaborator 540 includes a binary data model subordinator 1205 configured to determine addressable value dependencies between binary data model elements and to associate subordinate addresses with such elements.

In one or more embodiments, a dependency exists when the semantic interpretation, structural presence, or repetition of a first binary data model element requires the value of a second binary data model element. The binary data model subordinator 1205 may analyze binary rules, structural relationships, and addressable value references within the binary data model to identify such dependencies and represent the reverse dependency relationships between elements.

For example, a binary data model element may include a rule specifying repetition based on a dependency value derived from another element. In one embodiment, a “Message Block” element may include a repetition rule indicating that the number of instances of the Message Block is equal to the value of a field name “Message Count” located at a deterministic address such as udp.header.messagecount. The binary data model subordinator 1205 may associate the Message Block element with a subordinate address referencing the controlling field, thereby establishing an explicit reverse dependency relationship.

In one or more embodiments, the binary data model subordinator 1205 of the binary data model elaborator 540 produces a set of reverse dependency-aware or subordinate address mappings that may be consumed by other components, including iterator components, linearizers, or downstream generation systems. These annotations enable construction of ordered representations of binary data model elements in which traversal, evaluation, or instantiation proceeds in a manner consistent with the dependency structure of the model.

In one or more embodiments, the binary data model navigator 512 and the binary data model querier 516 may be used to identify and resolve addressable value dependencies. For example, the querier 516 may evaluate selection criteria corresponding to rules containing addressable value references, and the navigator 512 may resolve such references into deterministic addresses. In embodiments, the navigator 512 may store dependent relationships between the model elements as addressable references, and the binary model manipulator 520 may generate a set of transformed portions from those dependent relationships. The resulting dependency relationships may then be provided to the subordinator 1205 for incorporation into subordinate address mappings and dependency-aware ordering structures.

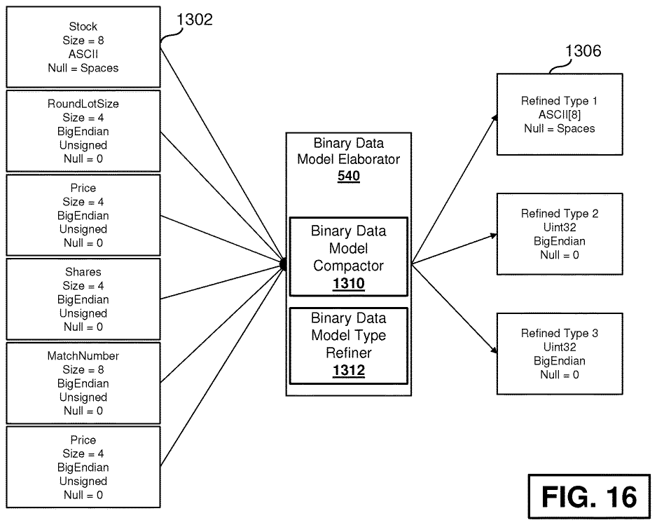

Referring to FIG. 16, the transformation engine 500 may comprise a binary data model elaborator 540 that includes a binary data model compactor 1310 that derives a comprehensive type system from the generic binary data model by evaluating the generic representations of binary data model type information. Type information may be represented as binary type traits 1302 associated with model elements, including attributes such as size, signedness, endianness, translation or scaling semantics, null representation, and optional transformation traits, and may also be represented in denormalized form across field-level attributes, implicit encodings, or derived semantics present in message definitions.

In one or more embodiments, the binary data model navigator 512 and the binary data model querier 516 cooperate to identify type-relevant attributes across the generic binary data model. The navigator 512 may resolve deterministic addresses of type-bearing elements, while the querier 516 may apply selection criteria such as binary type traits, field encodings, or semantic classifications to gather candidate type representations, including both explicitly defined types and implicit or derived types inferred from field attributes or transformation rules.

The binary data model compactor 1310 of the binary data model elaborator 540 may apply a compaction transformation in which the gathered type representations are normalized into canonical trait bundles, or normalized binary type traits 1306. Model elements that share identical combinations of traits may be grouped into equivalent types, producing a comprehensive calculated type list independent of specification-level identifiers or structural location within the model.

In one or more embodiments, the manipulation instructions 620 may further include an elaboration instruction that calculates a unique type identifier as a derived trait associated with each normalized trait bundle. The derived type identifier may be computed deterministically based on the normalized attributes of the trait bundle or assigned as a canonical name within the modified binary data model. This transformation converts type identity into a calculated trait, eliminating reliance on fixed predefined types or extensible type hierarchies.

In one or more embodiments, the normalized binary type traits 1306 produced by the compaction transformation may be stored in a type dictionary structure associated with the modified binary data model. The type dictionary may comprise a collection of common unique binary data model type entries, each entry corresponding to a unique normalized type trait bundle and including the associated derived type identifier, attribute set, and references to model elements that use the type. The type dictionary may be addressable within the binary data model and may support lookup, comparison, and reuse of type definitions across different portions of the model. In some embodiments, the type dictionary may be stored as a separate structure linked to the model, while in other embodiments it may be embedded within the model as a collection of addressable elements.

In one or more embodiments, a target programming language or domain-specific language generator may require type information that reflects fully resolved structural, dependency, and layout characteristics of the binary data model rather than abstract or specification-level type definitions. For example, certain targets may require knowledge of fixed-size structures, alignment guarantees, contiguous memory regions, or dependency-resolved repetition semantics prior to generation.

In one or more embodiments, the binary data model management system 1 further includes a binary data model type refiner 1312 configured to operate on normalized binary type traits and derived properties produced by the binary data model qualifier module 521 and binary data model calculator module 522 to generate refined type representations. The binary data model type refiner 1312 may evaluate type trait predicates and computed properties, including size, alignment, contiguity, dependency structure, and repetition expansion, and may produce target-consumable type definitions without requiring external type resolution or inference at the target generator.

In one or more embodiments, the binary data model type refiner 1312 applies transformation rules that incorporate structural specialization, constraint propagation, and target-specific adaptation. Such transformations may include resolving variable-length constructs into bounded or parameterized representations, grouping elements into contiguous regions, deriving fixed-layout structures from dependency-constrained elements, or introducing canonicalized representations suitable for vectorized processing, hardware mapping, or columnar storage.

For example, a sequence of fields identified by the binary data model qualifier module 521 as forming a contiguous, fixed-length region may be refined into a single composite type suitable for direct memory mapping in a C or C++ target, while a dependency-driven repeated group may be refined into an explicit iteration structure with bounds derived from calculated repetition constraints. Similarly, alignment requirements, padding rules, or encoding optimizations may be incorporated into the refined type representation based on calculated offsets and structural relationships within the model.

In one or more embodiments, refined type representations remain associated with the original normalized binary type traits and underlying binary data model elements through deterministic identifiers, enabling traceability between abstract model definitions and target-specific type realizations. This allows downstream programming language source code target generators to operate on refined types while preserving correspondence to the original generic binary data model.

Accordingly, the binary data model compactor 1310 illustrated in FIG. 16 enables systematic discovery, normalization, and transformation of type representations within a generic binary data model, leveraging the navigation, querying, and manipulation mechanisms described herein to produce a complete and computable type system suitable for generation and execution.

In one or more embodiments, the binary data model management system 1 further includes a binary data model decompactor configured to reconstruct expanded type representations from the compacted type system. Whereas the binary data model compactor 1310 produces normalized binary type traits and derived type identifiers by grouping equivalent type representations, the binary data model decompactor performs the inverse operation by mapping compacted representations back to structurally or semantically expanded forms suitable for binary data model navigating, querying and manipulation.

The binary data model decompactor may use the deterministic associations between derived type identifiers and their corresponding normalized binary type traits to regenerate field-level or element-level type representations within a binary data model or within a generated artifact. In some embodiments, the binary data model decompactor reconstructs denormalized type expressions, including field-specific attributes, encoding semantics, or structural variations that were abstracted during compaction.

In one or more embodiments, the binary data model decompactor operates as a complementary transformation stage within the binary data model transformation engine, enabling transitions between compacted and expanded representations without loss of semantic fidelity. This capability supports workflows in which compact representations are used for efficient computation, comparison, or dispatch, while expanded representations are required for generation of executable code, schema definitions, or human-readable artifacts.

Accordingly, the presence of both the binary data model compactor 1310 and binary data model decompactor of the binary data model management system 1 enables reversible transformation of type representations within the binary data model, allowing the binary data model management system 1 to selectively operate at different levels of abstraction depending on the requirements of a given transformation or generation task.

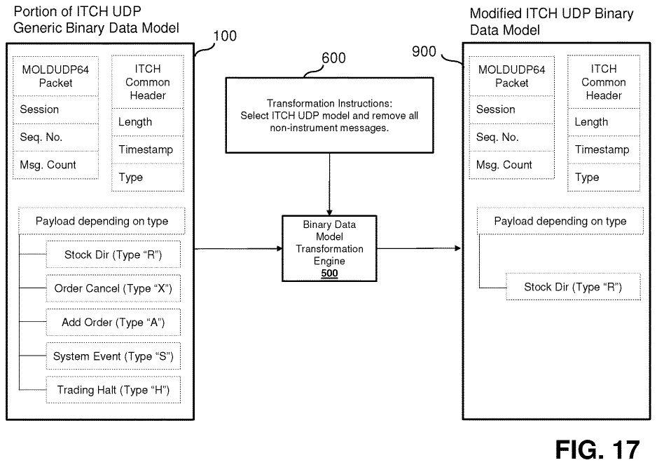

Referring to FIG. 17, binary data model transformation engine 500 described within may apply transformation instructions 600 to modify a binary data model 100. For example, binary data model transformation engine 500 may apply transformation instructions 600 to generate an instrument database by selectively extracting instrument-related message definitions from a generic binary data model and removing non-relevant message structures.

For example, a generic binary data model 100 representing a protocol such as ITCH over MoldUDP64 may include transport-level elements, including packet headers, session identifiers, sequence numbers, and message counts, together with a set of payload message types whose structure and interpretation depend on message type identifiers. These payload message types may include both instrument definition messages and non-instrument messages such as order entry, cancellation, or system event messages.

In one or more embodiments, transformation instructions 600 may specify selection criteria that identify instrument-related message types (e.g., instrument definition selection criteria) and their dependencies while excluding unrelated message types. Such instructions may include, for example, selecting messages associated with instrument definition, trading status, or reference data, and removing messages associated with order flow, execution, or administrative events.

The binary data model navigator 512 may apply navigation criteria derived from the search criteria 610 to the generic binary data model to identify the subset of model elements corresponding to the selected instrument-related message types. The navigator 512 may also traverse dependencies to include supporting elements such as referenced types, enumerations, and header fields required for correct interpretation of the selected messages.

The binary data model manipulator 520 may then apply manipulation operations that remove non-selected message types and recombine the remaining elements into a modified binary data model 900. In one or more embodiments, the binary data model manipulator 520 preserves transport-level structures, including packet headers and sequencing information, while restricting the payload definition to only the selected instrument-related message types. In one or more embodiments, the resulting modified binary data model 900 represents a reduced and specialized protocol model in which payload structures are limited to instrument-related messages, such as stock directory or trading halt messages, while other message types have been removed. The modified binary data model 900 may retain the original structural relationships and dependencies necessary for parsing and interpreting the remaining messages.

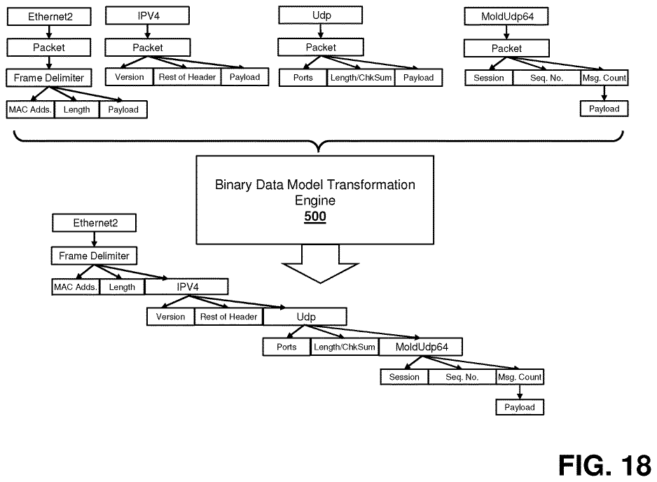

FIG. 18 illustrates a binary data model management system 1 generating a network-protocol-aware binary trading protocol decoder by combining multiple protocol layers into a unified processing representation. In the embodiment shown, elements corresponding to link-layer, network-layer, transport-layer, and application-layer protocols—including Ethernet, IPv4, UDP, and MoldUDP64—are represented as portions of a generic binary data model and are provided to the binary data model transformation engine 500. The transformation engine 500 is configured to receive these protocol-layer model elements and to generate a combined model that reflects both the structural layout and the sequential interpretation of packets across the protocol stack.

In one or more embodiments, the binary data model transformation engine 500 may use the binary data model navigator 512 and the binary data model manipulator 520 to identify and select model elements corresponding to each protocol layer (e.g., protocol-layer model elements), including fields such as frame delimiters, MAC addresses, version indicators, header fields, length and checksum fields, port identifiers, session identifiers, sequence numbers, message counts, and payload structures. The binary data model navigator 512 is configured to resolve deterministic addresses across multiple protocol namespaces, thereby enabling selection of structurally related elements spanning distinct protocol layers. The binary data model manipulator 520 is configured to reorganize and combine these selected elements into a unified binary data model representation that preserves inter-layer relationships and ordering constraints.

In one or more embodiments, the binary data model manipulator 520 applies manipulation instructions to remove redundant structural boundaries between protocol layers and to merge header and payload elements into a contiguous representation. This may include collapsing intermediate container elements, normalizing field ordering based on physical packet layout, and reconciling dependencies between fields originating from different protocol layers. The resulting modified binary data model 900 may represent a packet structure in which elements from Ethernet, IPv4, UDP, and MoldUDP64 are arranged in execution order corresponding to their appearance in a binary data stream.

In one or more embodiments, the binary data model transformation engine 500 may further apply elaboration options to the combined model to produce a specialized binary data model 920 tailored for a programming language target generation. For example, elaboration may include computing offsets across the unified packet structure, deriving composite field representations, annotating dependency relationships between transport-level and application-level elements, and generating intermediate representations suitable for hardware or software execution. The specialized model 920 may be configured for use in generating a protocol processor that is aware of multiple protocol layers and capable of processing binary data streams with reduced parsing overhead.

In the embodiment shown, the transformation engine 500 produces an output representation in which protocol-layer distinctions are preserved logically but integrated structurally, enabling downstream generators to produce implementations such as FPGA-based packet processors, low-latency feed handlers, or analytics pipelines. The generated processor may operate on a unified model of packet data, allowing direct access to fields across layers without requiring separate parsing stages for each protocol. This integrated representation supports efficient processing of binary trading data by reducing indirection and enabling optimized execution paths.

As further illustrated in FIG. 18, the transformation process may include selective reduction of message types or payload structures within the application-layer protocol. In some embodiments, the manipulation instructions may specify that only a subset of message types be retained, thereby increasing the speed and reducing the complexity of the resulting decoder. For example, the binary data model manipulator 520 may remove non-essential message definitions and their associated dependencies, producing a reduced model suitable for implementation in constrained environments such as FPGA devices. The resulting specialized binary data model 920 may therefore represent both a multi-layer protocol integration and a workload-specific reduction of processing scope.

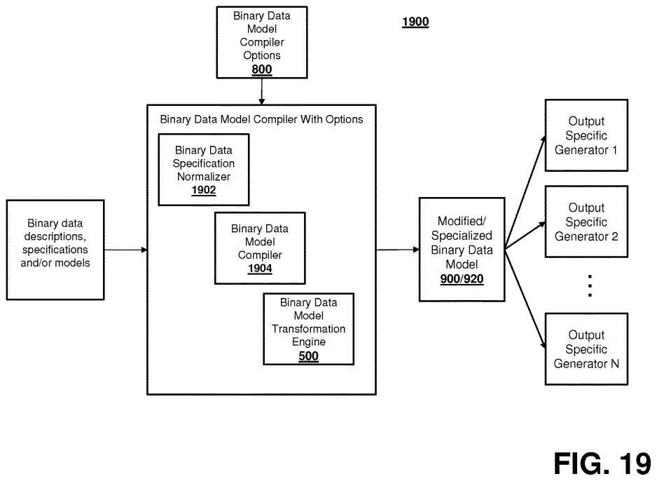

FIG. 19 illustrates a computing system comprising a source generation platform configured to operate as a compiler system 1900 that produces specialized binary data model representations and corresponding outputs based on compiler options stored in the memory (e.g., memory 1504 of the computing device 1500 shown in FIG. 20). In one or more embodiments, the compiler options 800 specify input sources of the generic binary data model 100, including binary descriptions, specifications, or other artifacts, and may further define output targets for the modified binary data model 900 and transformation instructions (e.g., the set of transformation instructions 600). The platform may include a binary data specification normalizer 1902 configured to obtain and standardize inputs, and a binary data model compiler 1904 configured to construct one or more generic binary data models, in some embodiments using techniques described in U.S. Pat. No. 12,101,388 and U.S. Patent Application Publication No. 2024/0419416, each of which is incorporated herein by reference in its entirety.

In one or more embodiments, the compiler system 1900 (specifically, the binary data model manipulator 520 of the transformation engine 500) generates output artifacts for one or more output targets specified by the compiler options 800 by applying the transformation instructions 600 derived from the set of compiler options 800 to the modified binary data model 900 or the specialized binary data model 920. Here, the output artifacts may include executable programs, intermediate representations, or hardware configurations. As used herein, the intermediate representation refers to a machine-processable representation derived from the generic, modified, manipulated, or specialized binary data models that preserves at least a portion of the structural, semantic, type, layout, ordering, or dependency information of the binary data model in a form adapted for use by a downstream processor, analyzer, compiler, or output generator. The compiler options 800 may influence transformation operations, traversal strategies, and generation pathways, such that different option configurations produce distinct outputs from the same inputs. One skilled in the art will recognize that such option-driven control of inputs, intermediate representations, and outputs corresponds to compiler design principles applied to binary data model representations. The system may operate on generic binary data models from any source, forming a unified option-driven compiler framework.

In one or more embodiments, the compiler system 1900 generates output artifacts from the specialized binary data models, including executable programs, intermediate representations, or hardware configurations. The compiler options 800 may influence transformation operations, traversal strategies, and generation pathways, such that different option configurations produce distinct outputs from the same inputs. One skilled in the art will recognize that such option-driven control of inputs, intermediate representations, and outputs corresponds to compiler design principles applied to binary data model representations. The system may operate on generic binary data models from any source, forming a unified option-driven compiler framework.

Referring to FIG. 20, a block diagram of an exemplary computing device 1500 for creating a modified binary data model 900 is shown according to the methods, steps, or operations described in the present disclosure. The computing system 1500 may include one or more processors 1502, memory 1504, file systems 1512, I/O interfaces 1518, and network devices 1520. The computing device implements components including a binary data model retriever 510, binary data model manipulator 520, binary data model harmonizer 530, and binary data model elaborator 540 interconnected via a bus 1508. The memory 1504 stores the generic binary data model 100 and instructions that, when executed, perform navigation, manipulation, recombination, and generation operations.

In one example, the computing device 1500 may transmit input and output signals via, for example, I/O Ports 1510 or I/O Interfaces 1518. In the configuration shown in FIG. 20, computing device 1500 includes the binary data model transformation engine 500 illustrated in FIG. 12. In embodiments, the processor 1502 of the computing device 1500 may execute a computer program stored in the memory 1504 to implement the functions of the retriever 510, manipulator 520, harmonizer 530, and elaborator 540, which operate as described elsewhere herein. The binary data model transformation engine 500 and its associated components may be implemented in the computing device 1500 as hardware, firmware, software, or combinations thereof and, thus, the computing device 1500 and its components may provide means for performing functions described herein as performed by the binary data model transformation engine and its associated components as shown in FIG. 9.

Still referring to FIG. 20, the processor 1502 can include a variety of various processors including dual microprocessor and other multi-processor architectures. The memory 1504 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 1506 may be operably connected to the computing device 1500 via, for example, I/O Interfaces (e.g., card, device) 1518 and an I/O Ports 1510. The disk 1506 can include, but is not limited to, devices like a magnetic disk drive, a solid-state disk drive, a floppy disk drive, a tape drive, a flash memory card, or a memory stick. Furthermore, the disk 1506 can include optical drives like a CD-ROM, a CD recordable drive (CD-R drive), a CD rewriteable drive (CD-RW drive), or a digital video ROM drive (DVD ROM). The memory 1504 can store processes 1514 or data 1516, for example. The disk 1506 or memory 1504 can store an operating system that controls and allocates resources of the computing device 1500.

The bus 1508 can be a single internal bus interconnect architecture or other bus or mesh architectures. While a single bus is illustrated, it is to be appreciated that the computing device 1500 may communicate with various devices, logics, and peripherals using other busses that are not illustrated (e.g., PCIE, SATA, Infiniband, 1394, USB, Ethernet). The bus 1508 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The computing device 1500 may interact with input/output devices via I/O Interfaces 1518 and I/O Ports 1510. Input/output devices can include, but are not limited to, a keyboard, a microphone, a pointing and selection device, cameras, video cards, displays, disk 1506, network devices 1520, and the like. The I/O Ports 1510 can include but are not limited to, serial ports, parallel ports, and USB ports.

The computing device 1500 can operate in a network environment and thus may be connected to network devices 1520 via the I/O Interfaces 1518, or the I/O Ports 1510. Through the network devices 1520, the computing device 1500 may interact with a network. Through the network, the computing device 1500 may be logically connected to remote devices. The networks with which the computing device 1500 may interact include, but are not limited to, a local area network (LAN), a wide area network (WAN), and other networks. The network devices 1520 can connect to LAN technologies including, but not limited to, fiber distributed data interface (FDDI), copper distributed data interface (CDDI), Ethernet (IEEE 302.3), token ring (IEEE 302.5), wireless computer communication (IEEE 302.11), Bluetooth (IEEE 302.15.1), Zigbee (IEEE 302.15.4) and the like. Similarly, the network devices 1520 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

While the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other example methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, computer-executable program instructions, such as program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

“Binary data” refers to any data represented in binary form and is a sequence of bits or bytes.

A “binary description” is any documentation, technical note, programming language source code, or domain specific language describing any part of a binary communication protocol, binary data file format and/or binary data processing architecture.

A “binary header” is a binary data structure used for relaying information about a binary packet, binary message, binary file or other binary data structure.

“Binary information” is any information stored, processed, or transmitted as binary data.

A “binary message” is a binary data structure transmitted over a network used primarily to signal a specific event or update in a binary communication protocol.

A “binary specification” describes the required set of binary fields and rules for encoding/decoding a binary communication protocol, binary data storage format, and/or binary data processing architecture. Binary specifications may optionally contain binary actions for modeling complex behavior.

A “binary dependency” is any binary field that requires information or data contained in another binary data field for its own encoding/decoding.

A “binary subordinate” is any binary field that contains information or data required for encoding/decoding another binary data field.

A “derived field” is a binary data model element that is not explicitly defined in an originating specification but is generated within the binary data model through computation, inference, or transformation based on one or more existing elements, relationships, or rules.

A “generic binary data model” is an independent intermediate representation for modeling binary data fields, parsing rules and behavior of a binary communication protocol, binary data file format or binary data processing architecture.

A “manipulated binary data model” refers to a binary data model produced by applying one or more manipulation operations to a generic, modified or other manipulated binary data model, wherein such operations modify structural relationships, attributes, or dependencies of model elements while preserving the model's viability as an input to a system or component that expects a generic binary data model representation.

A “normalized binary specification” is any binary specification created using a normalization or standardization process.

A “normalized binary specification component” contains standardized technical details for a component of a normalized binary specification.

A “specialized binary data model” refers to a binary data model derived from a generic binary data model through one or more transformation operations that adapt the model for a specific target context, execution environment, or processing objective.

What is claimed is:

1. A binary data model management method for implementation by a computing system including:
a processor, and
a memory storing computer-executable instructions that, when executed by the processor, cause the computing system to perform the binary data model management method, the binary data model management method comprising:
storing, in the memory, a generic binary data model describing structure and semantics of binary data, the generic binary data model including a set of model elements that define how binary data is structured and decoded in a binary communication protocol;
storing, in the memory, a set of transformation instructions defining modifications to be applied to the generic binary data model;
parsing, using a binary data model retriever, the set of transformation instructions to extract:
a set of search criteria that designate conditions for selecting model elements of the set of model elements in the generic binary data model, and
a set of manipulation instructions that define a) selection categories that classify the set of model elements into one or more groups and b) manipulation operations associated with the selection categories;
identifying, by using the binary data model retriever to apply the set of search criteria to the generic binary data model stored in the memory, a set of selected model portions of the generic binary data model that include selected model elements from among the set of model elements that satisfy the set of search criteria;
storing, by a binary data model manipulator, in association with each selected model portion of the set of selected model portions in the memory, at least one manipulation operation corresponding to the selection category of the selected model portion;
generating, by the binary data model manipulator, a set of transformed portions by applying the associated manipulation operations to respective selected model portions of the set of selected model portions in the memory; and
generating, by the binary data model manipulator, a modified binary data model usable at least for generating programming language source code by combining the set of transformed portions.

2. The method of claim 1, wherein the generic binary data model represents a binary communication protocol, binary data storage format, and/or binary data processing architecture as a normalized collection of model elements including at least one of messages, fields, groups, types, enumerations, constants, rules, constraints, metadata attributes, implicit indexes, offsets, lengths, or dependencies.

3. The method of claim 1, wherein:
the binary data model retriever further includes a binary data model navigator;
parsing the set of transformation instructions includes:
parsing, by the binary data model navigator, the set of transformation instructions to extract, as the set of search criteria, a set of navigation criteria defining address search parameters for locating the selected model elements within the generic binary data model; and identifying the set of selected model portions includes:
identifying, by the binary data model navigator, the selected model elements from among the set of model elements that satisfy the set of address search parameters of the set of navigation criteria,
resolving, for the selected model elements, deterministic addresses within the generic binary data model, the deterministic addresses being derived from at least one of a structural position, hierarchical path, canonical ordering, or content-derived hashing of the set of model elements,
gathering candidate portions of the generic binary data model that include one or more of the selected model elements; and
selecting, as the set of selected model portions, the candidate portions of the generic binary data model that include the selected model elements.

4. The method of claim 3, wherein:
identifying the set of selected model portions includes:
identifying, by the binary data model navigator, addressable value dependencies between model elements of the set of model elements;
storing, by the binary data model navigator in response to identifying the addressable value dependencies, dependent relationships between the model elements of the set of model elements as addressable references; and
generating the set of transformed portions includes annotating, by the binary data model manipulator, at least one dependent model element with dependency metadata indicating a dependent relationship with another model element.

5. The method of claim 1, wherein the set of search criteria designates at least one of an element name, metadata characteristic, structural position, type trait, dependency relationship, namespace segment, or address pattern of the set of model elements.

6. The method of claim 1, wherein:
the set of search criteria includes one or more logical expressions including at least one of conjunction, disjunction, negation, or grouping; and identifying the set of selected model portions includes evaluating the logical expressions against attributes of the set of model elements.

7. The method of claim 1, wherein:
the binary data model retriever further includes a binary data model querier; and parsing the set of transformation instructions includes:
parsing, by the binary data model querier, the set of transformation instructions to extract, as the set of search criteria, a set of binary data model selection criteria for comparison with the set of model elements, the set of binary data model selection criteria including properties, fields, rules, traits, or addresses of the generic binary data model; and
identifying the set of selected model portions includes:
identifying, by comparing the set of binary data model selection criteria with the set of model elements, the selected model elements from among the set of model elements that satisfy the set of binary data model selection criteria;
gathering candidate portions of the generic binary data model that include one or more of the selected model elements; and
selecting, as the set of selected model portions, the candidate portions of the generic binary data model that include the selected model elements.

8. The method of claim 7, wherein identifying the selected model elements includes:
traversing, by the binary data model querier, conceptual relationships associated with the set of model elements to select, in addition to a first selected model element, at least one related model element comprising at least one of a descendant element, a referenced type element, a dependent element, or a rule-related element.

9. The method of claim 1, wherein:
the selection categories classify the model elements into groups selected from message-level elements, header elements, payload elements, timestamp elements, instrument identifier elements, enumeration elements, or field-level elements, and
generating the set of transformed portions includes applying, by the binary data model manipulator, different manipulation operations to different groups.

10. The method of claim 1, wherein generating the set of transformed portions includes performing, by the binary data model manipulator, at least one manipulation operation including at least one of:
adding a derived model element,
removing a model element,
editing an attribute value,
renaming a model element,
rearranging a sequence of elements,
splitting a model element,
combining model elements,
rewriting a dependency, or propagating metadata.

11. The method of claim 1, wherein:
the manipulation operations include injecting, by the binary data model manipulator, at least one derived model element representing at least one of a derived offset, derived length, derived index, derived type name, or derived semantic field, and
combining, by the binary data model manipulator, the set of transformed portions includes incorporating the derived model element into the modified binary data model.

12. The method of claim 1, further comprising:
identifying, by a binary data model harmonizer, one or more conflicts within the modified binary data model; and
revising, by the binary data model harmonizer, the modified binary data model to eliminate the one or more conflicts and generate a manipulated binary data model.

13. The method of claim 12, wherein:
the one or more conflicts include structural inconsistencies or unresolved dependencies;
revising the modified binary data model to eliminate the one or more conflicts includes one or more of resolving unresolved dependencies, reconciling structural relationships, or normalizing the modified binary data model.

14. The method of claim 12, wherein:
revising the modified binary data model to eliminate the one or more conflicts includes one or more of updating dependency references.

15. The method of claim 1, further comprising:
extracting, from the set of transformation instructions using the binary data model retriever, a set of elaboration options that specify one or more requirements for the modified binary data model; and
generating, by using a binary data model elaborator to apply the set of elaboration options to the modified binary data model such that the set of model elements in the modified binary data model conform to the requirements specified by the set of elaboration options, a specialized binary data model.

16. The method of claim 15, wherein the set of elaboration options includes one or more of: type normalization, structural annotation, dependency expansion, or derived attribute generation.

17. The method of claim 15, wherein generating the specialized binary data model by applying the set of elaboration options to the modified binary data model further comprises:
linearizing, by the binary data model elaborator, the modified binary data model in a canonical order.

18. The method of claim 15, wherein generating the specialized binary data model by applying the set of elaboration options to the modified binary data model further comprises:
gathering, by a binary data model compactor, from the set of model elements of the modified binary data model, a set of candidate type representations including type-relevant attributes of the set of model elements;
normalizing, by the binary data model compactor, the gathered candidate type representations into a set of normalized binary type traits, each normalized binary type trait including a combination of type attributes of a model element;
grouping, by the binary data model compactor, model elements of the set of model elements that share an identical combination of normalized binary type traits into a calculated type list; and
injecting, by the binary data model compactor into each entry of the calculated type list, a calculated unique type identifier as a derived trait of the model elements in the entry, the calculated unique type identifier being computed from the normalized binary type traits of the model elements in the entry.

19. The method of claim 18, further comprising:
mapping, by a binary data model decompactor, at least one entry of the calculated type list to its corresponding combination of normalized binary type traits; and
regenerating, by the binary data model decompactor from the mapped combination of normalized binary type traits, at least one expanded type representation including type-relevant attributes of one or more model elements of the calculated type list.

20. The method of claim 15, wherein generating the specialized binary data model by applying the set of elaboration options to the modified binary data model further comprises:
refining, by a binary data model type refiner, normalized binary type traits of the set of model elements of the modified binary data model into target-specific type representations by evaluating type trait predicates and computed structural properties;
wherein the refining includes at least one of: resolving variable-length constructs into bounded representations; grouping model elements forming a contiguous memory region into a composite type; or deriving a fixed-layout structure from dependency-constrained model elements; and wherein each refined type representation retains a deterministic association with its originating normalized binary type traits.

21. The method of claim 15, wherein generating the specialized binary data model by applying the set of elaboration options to the modified binary data model further comprises:
determining, by a binary data model subordinator, addressable value dependencies between the set of model elements of the modified binary data model in response to identifying that a semantic interpretation, structural presence, or repetition of a first model element requires a value of a second model element; and
producing, by the binary data model subordinator, a set of dependency-aware subordinate address mappings that associate each dependent model element with a deterministic address of the model element on which it depends.

22. The method of claim 15, wherein generating the specialized binary data model by applying the set of elaboration options to the modified binary data model further comprises:
generating, by a binary data model linearizer, a linear intermediate representation of the set of model elements of the modified binary data model that preserves sequential ordering and dependency relationships defined within the modified binary data model.

23. The method of claim 1, wherein:
storing the generic binary data model includes storing, in the memory, a generic binary data model that represents a plurality of protocol layers;
identifying the set of selected model portions includes selecting, by the binary data model retriever, protocol-layer model elements of the set of model elements from at least two protocol layers of the plurality of protocol layers; and
generating the modified binary data model includes combining, by the binary data model manipulator, the protocol-layer model elements into a unified model representing the plurality of protocol layers.

24. The method of claim 1, further comprising:
generating an executable software program using the modified binary data model,
wherein the executable software program includes one or more of a parser, decoder, encoder, protocol analyzer, packet capture inspection tool, header extraction program, storage format converter, compression program, or analytic program.

25. The method of claim 1, wherein the binary data model retriever includes a binary data model qualifier module, the method further comprising:
evaluating, by the binary data model qualifier module, one or more type trait predicates against model elements of the set of model elements based on structural relationships, binary data model values, characteristics, and dependencies within the generic binary data model; and
associating, by the binary data model qualifier module, with each model element satisfying a type trait predicate, a derived binary type trait as a normalized attribute of the model element, wherein the derived binary type trait is deterministically addressable within the generic binary data model.

26. The method of claim 1, wherein the binary data model retriever includes a binary data model calculator module, the method further comprising:
computing, by the binary data model calculator module, one or more quantitative structural properties of model elements of the set of model elements by traversing the generic binary data model and evaluating dependency relationships thereof, wherein the quantitative structural properties include at least one of: a byte size, a bit width, a relative offset, an absolute offset, a repetition-expanded size, a dependency depth, or a structural span; and
storing the computed quantitative structural properties as derived properties associated with corresponding model elements in the generic binary data model.

27. The method of claim 1, further comprising:
traversing, by a binary data model element iterator, model elements of the modified binary data model according to a selected traversal strategy defining an operation execution sequence; and
invoking, during traversal, a first element-specific operation associated with a first model element and a second element-specific operation associated with a second model element on which the first model element depends, wherein the first element-specific operation is invoked after execution of the second element-specific operation.

28. The method of claim 1, further comprising:
storing, in the memory, a set of compiler options defining a) the set of transformation instructions and b) one or more output targets for the modified binary data model; and
generating, by the binary data model manipulator, an output artifact for the one or more output targets by applying the transformation instructions derived from the set of compiler options, the output artifact including one or more of an executable program, an intermediate representation, or a hardware configuration.

29. A binary data model management system including:
a processor, and
a memory storing computer-executable instructions that, when executed by the processor, cause the processor to:
store, in the memory, a generic binary data model describing structure and semantics of binary data, the generic binary data model including a set of model elements that define how binary data is structured and decoded in a binary communication protocol;
store, in the memory, a set of transformation instructions defining modifications to be applied to the generic binary data model;
parse, using a binary data model retriever, the set of transformation instructions to extract:
a set of search criteria that designate conditions for selecting model elements of the set of model elements in the generic binary data model, and
a set of manipulation instructions that define a) selection categories that classify the set of model elements into one or more groups and b) manipulation operations associated with the selection categories;
identify, by using the binary data model retriever to apply the set of search criteria to the generic binary data model in the memory, a set of selected model portions of the generic binary data model that include selected model elements that satisfy the set of search criteria;
store, by a binary data model manipulator, in association with each selected model portion of the set of selected model portions in the memory, at least one manipulation operation corresponding to the selection category of the selected model portion;
generate, by the binary data model manipulator, a set of transformed portions by applying the associated manipulation operations to respective selected model portions of the set of selected model portions in the memory; and
generate, by the binary data model manipulator, a modified binary data model usable for generating an executable software program by combining the set of transformed portions.

30. A binary data model management method for implementation by a computing system including:
a processor, and
a memory storing computer-executable instructions that, when executed by the processor, cause the computing system to perform the binary data model management method, the binary data model management method comprising:
storing, in the memory, a generic binary data model describing structure and semantics of binary data, the generic binary data model including a set of model elements that define how binary data is structured and decoded in a binary communication protocol;
storing, in the memory, a set of transformation instructions defining modifications to be applied to the generic binary data model;
parsing, using a binary data model retriever, the set of transformation instructions to extract:
a set of search criteria that designate conditions for selecting model elements of the set of model elements in the generic binary data model, and
a set of manipulation instructions that define a) selection categories that classify the set of model elements into one or more groups and b) manipulation operations associated with the selection categories;
identifying, by using the binary data model retriever to apply the set of search criteria to the generic binary data model stored in the memory, a set of selected model portions of the generic binary data model that include selected model elements from among the set of model elements that satisfy the set of search criteria;
storing, by a binary data model manipulator, in association with each selected model portion of the set of selected model portions in the memory, at least one manipulation operation corresponding to the selection category of the selected model portion;
generating, by the binary data model manipulator, a set of transformed portions by applying the associated manipulation operations to respective selected model portions of the set of selected model portions in the memory;
generating, by the binary data model manipulator, a modified binary data model usable at least for generating programming language source code by combining the set of transformed portions;
identifying, by a binary data model harmonizer, one or more conflicts within the modified binary data model;
revising, by the binary data model harmonizer, the modified binary data model to eliminate the one or more conflicts and generate a manipulated binary data model;
extracting, from the set of transformation instructions using the binary data model retriever, a set of elaboration options that specify one or more requirements for the manipulated binary data model; and
generating, by using a binary data model elaborator to apply the set of elaboration options to the manipulated binary data model such that the set of model elements in the manipulated binary data model conform to the requirements specified by the set of elaboration options, a specialized binary data model.
